(19) United States
(12) Patent Application Publication
(10) Pub. No.: US 2025/0377888 A1
(43) Pub. Date: Dec. 11, 2025

(54) VECTOR EXTRACT AND MERGE INSTRUCTION

(71) Applicant: Arm Limited, Cambridge (GB)

(72) Inventor: Thomas Christopher Grocutt, Cambridge (GB)

(73) Assignee: Arm Limited, Cambridge (GB)

(21) Appl. No.: 18/877,106

(22) PCT Filed: Jun. 14, 2023
(86) PCT No.: PCT/GB2023/051544

§ 371 Date: Dec. 19, 2024

(30) Foreign Application Priority Data
Jun. 30, 2022 (GB) 2209637.4

(51) Int. Cl. G06F 9/30

(52) U.S. Cl. CPC G06F 9/30036; G06F 9/30032; G06F 9/30109; G06F 9/30145

(57) ABSTRACT

There is provide an apparatus, method and medium. The apparatus comprises decoder circuitry to generate control signals in response to a vector extract and merge instruction specifying a control parameter, a first vector register, a second vector register, and a destination vector register. The apparatus comprises processing circuitry responsive to the control signals, to perform plural beats of processing, each beat comprising processing corresponding to a portion of at least the first vector register and the destination vector register. The processing, for a K^{th} beat comprises: extracting bits, specified by the control parameter, from a K^{th} portion of the first vector register, concatenating the bits with further bits, and storing the result in the K^{th} portion of the destination register. The further bits are, for a first portion, extracted from a first portion of the second vector register and, otherwise, from a (K−1)^{th} portion of the first vector register.

The present techniques relate to an apparatus, a method of operating an apparatus and a computer readable medium to store computer-readable code for fabrication of an apparatus.

Some data processing systems support processing of vector instructions for which a source operand or result value of the instruction is a vector comprising multiple portions. By supporting the processing of a number of distinct portions of the vectors in response to a single instruction, code density can be improved and the overhead of fetching and decoding of instructions reduced. Sometimes, it is desirable that vector instructions are performed where the portions of the vectors are dependent on one another.

According to some configurations there is provided an apparatus comprising:
a plurality of vector registers;
decoder circuitry responsive to a vector extract and merge instruction to generate control signals, the vector extract and merge instruction specifying a control parameter and, as specified registers of the plurality of vector registers, a first source vector register, a second source vector register, and a destination vector register; and
processing circuitry responsive to the control signals to perform a plurality of beats of processing, each beat comprising combination processing corresponding to a portion of at least the first source vector register and the destination vector register, wherein the processing circuitry is configured to set beat status information indicative of which beats of the vector extract and merge instruction have completed, and to suppress completed beats of the vector extract and merge instruction indicated by the beat status information as having completed,
wherein the combination processing for a K^{th} beat corresponding to a K^{th} portion of each of the specified registers comprises:
extracting bits, as specified by the control parameter, from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register.

According to some configurations there is provided a method of operating an apparatus comprising a plurality of vector registers, decoder circuitry and processing circuitry, the method comprising:
generating, using the decoder circuitry and in response to a vector extract and merge instruction, control signals, the vector extract and merge instruction specifying a control parameter and, as specified registers of the plurality of vector registers, a first source vector register, a second source vector register, and a destination vector register; and
performing, using the processing circuitry and in response to the control signals, a plurality of beats of processing, each beat comprising combination processing corresponding to a portion of at least the first source vector register and the destination vector register, setting beat status information indicative of which beats of the vector extract and merge instruction have completed, and suppressing completed beats of the vector extract and merge instruction indicated by the beat status information as having completed,
wherein the combination processing for a K^{th} beat corresponding to a K^{th} portion of each of the specified registers comprises:
extracting bits specified by the control parameter from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register

According to some configurations there is provided a computer-readable medium to store computer-readable code for fabrication of an apparatus comprising:
a plurality of vector registers;
decoder circuitry responsive to a vector extract and merge instruction to generate control signals, the vector extract and merge instruction specifying a control parameter and, as specified registers of the plurality of vector registers, a first source vector register, a second source vector register, and a destination vector register; and
processing circuitry responsive to the control signals to perform a plurality of beats of processing, each beat comprising combination processing corresponding to a portion of at least the first source vector register and the destination vector register, wherein the processing circuitry is configured to set beat status information indicative of which beats of the vector extract and merge instruction have completed, and to suppress completed beats of the vector extract and merge instruction indicated by the beat status information as having completed,
wherein the combination processing for a K^{th} beat corresponding to a K^{th} portion of each of the specified registers comprises:
extracting bits specified by the control parameter from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register.

In some configurations the computer-readable medium is a non-transitory computer-readable medium.

According to some configurations there is provided a computer program for controlling a host data processing apparatus to provide an instruction execution environment, comprising:
register logic comprising a plurality of vector registers;
decoder logic responsive to a vector extract and merge instruction to generate control signals, the vector extract and merge instruction specifying a control parameter and, as specified registers of the plurality of vector registers, a first source vector register, a second source vector register, and a destination vector register; and
processing logic responsive to the control signals to perform a plurality of beats of processing, each beat comprising combination processing corresponding to a portion of at least the first source vector register and the destination vector register, wherein the processing logic is configured to set beat status information indicative of which beats of the vector extract and merge instruction have completed, and to suppress completed beats of the vector extract and merge instruction indicated by the beat status information as having completed,
wherein the combination processing for a K^{th} beat corresponding to a K^{th} portion of each of the specified registers comprises:
extracting bits specified by the control parameter from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register.

In some configurations the computer program is recorded on a non-transitory computer-readable medium.

The present techniques will be described further, by way of example only, with reference to configurations thereof as illustrated in the accompanying drawings, in which:

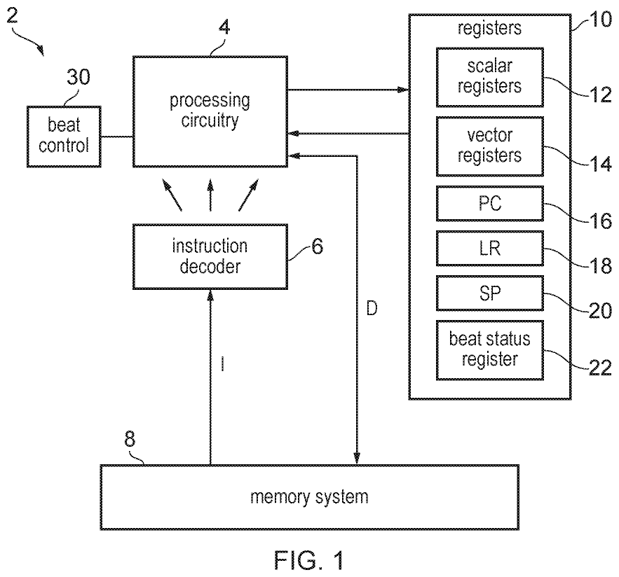

FIG. 1 schematically illustrates a data processing apparatus supporting processing of vector instructions according to various configurations of the present techniques;

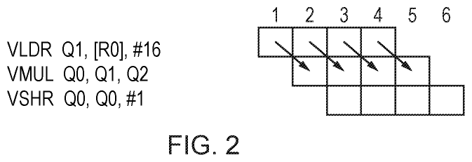

FIG. 2 schematically illustrates an example of overlapped execution of vector instructions according to various configurations of the present techniques;

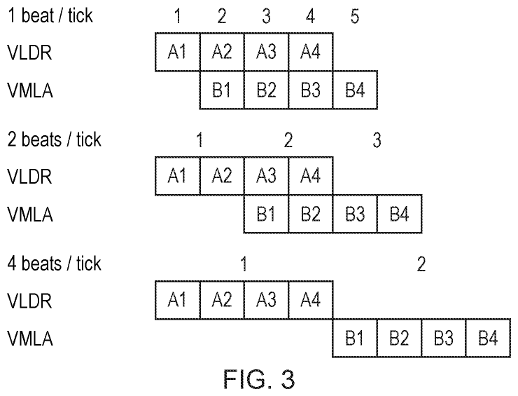

FIG. 3 schematically illustrates three examples of scaling the amount of overlap between successive vector instructions between different processor implementations or at run time between different instances of execution of the instructions according to various configurations of the present techniques;

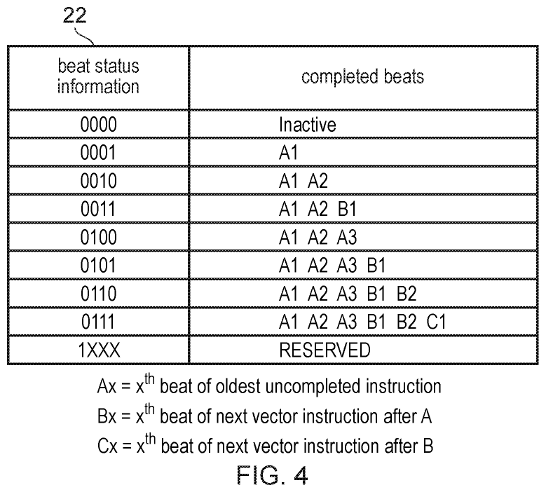

FIG. 4 schematically illustrates an example encoding for beat status information for indicating which beats of a block of multiple vector instructions have completed according to various configurations of the present techniques;

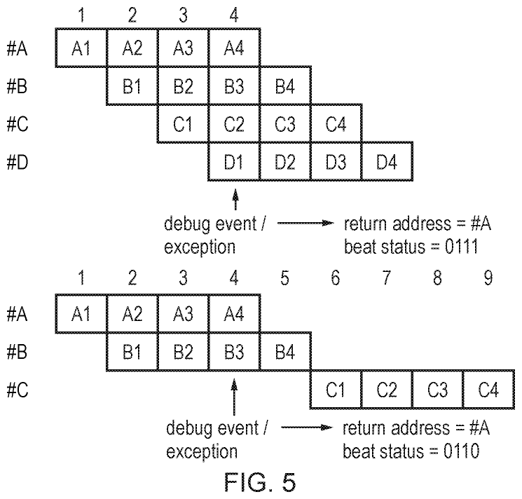

FIG. 5 schematically illustrates two examples of recording beat status information on the occurrence of a debug event or exception according to various configurations of the present techniques;

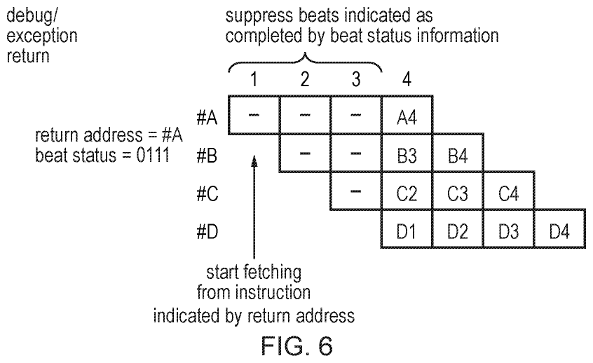

FIG. 6 schematically illustrates an example of using beat status information to resume processing following return from the debug event or exception according to various configurations of the present techniques;

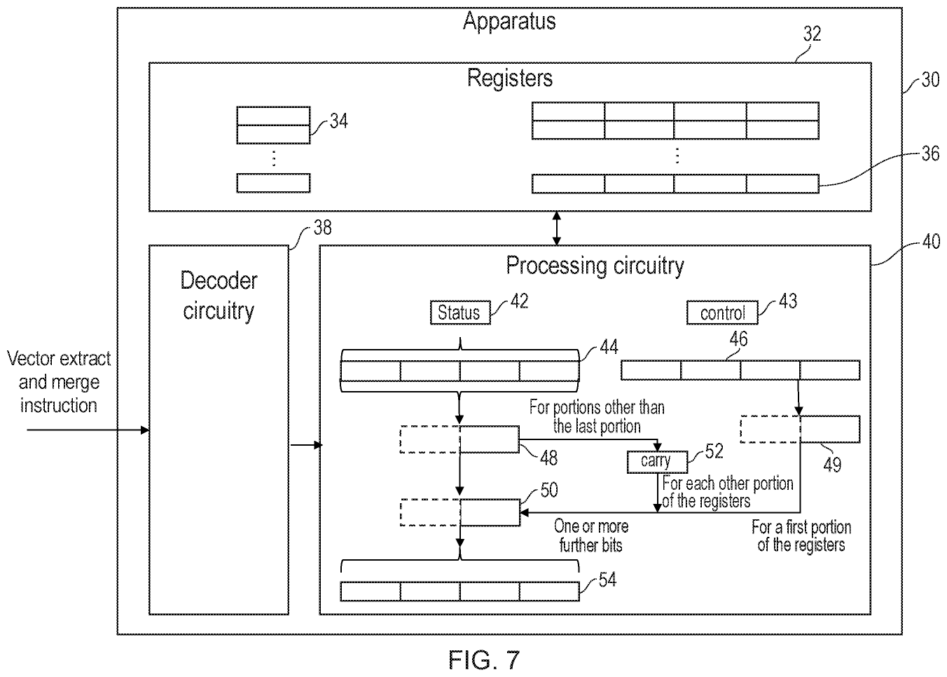

FIG. 7 schematically illustrates a data processing apparatus according to various configurations of the present techniques;

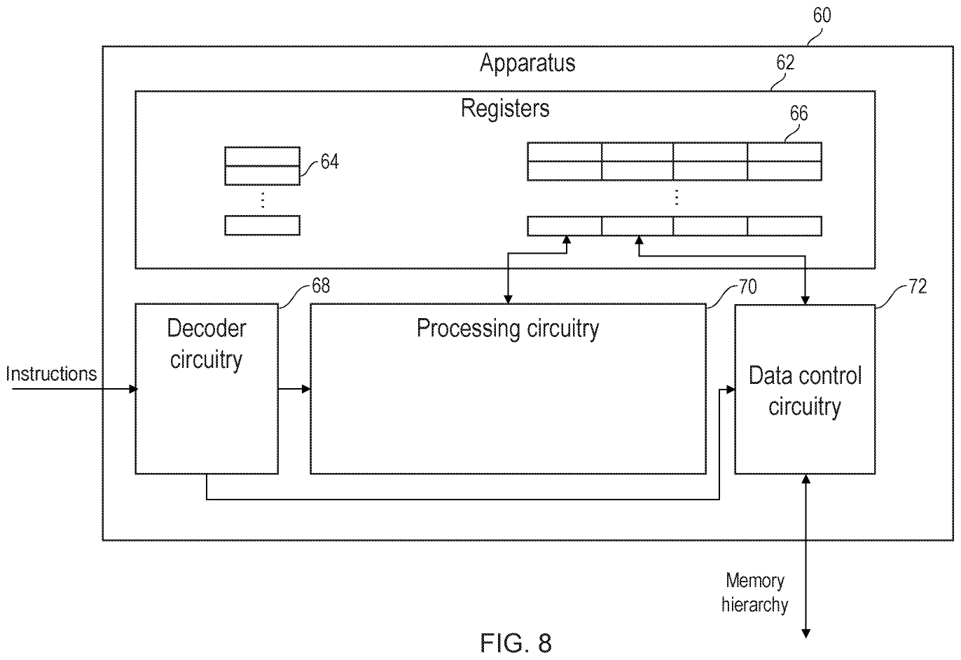

FIG. 8 schematically illustrates a data processing apparatus according to various configurations of the present techniques;

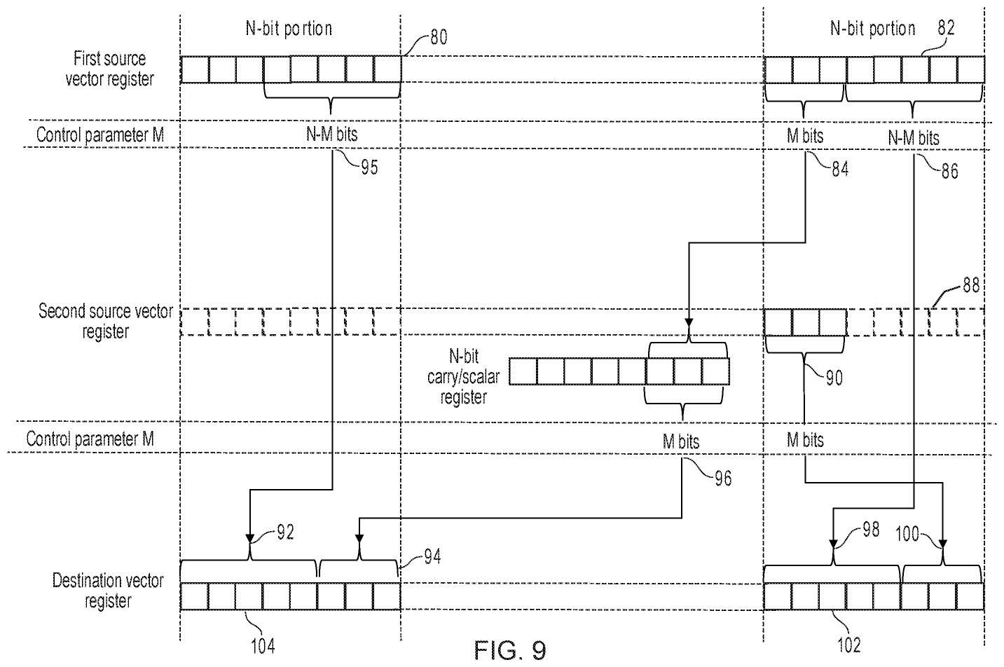

FIG. 9 schematically illustrates an example of a vector extract and merge instruction according to various configurations of the present techniques;

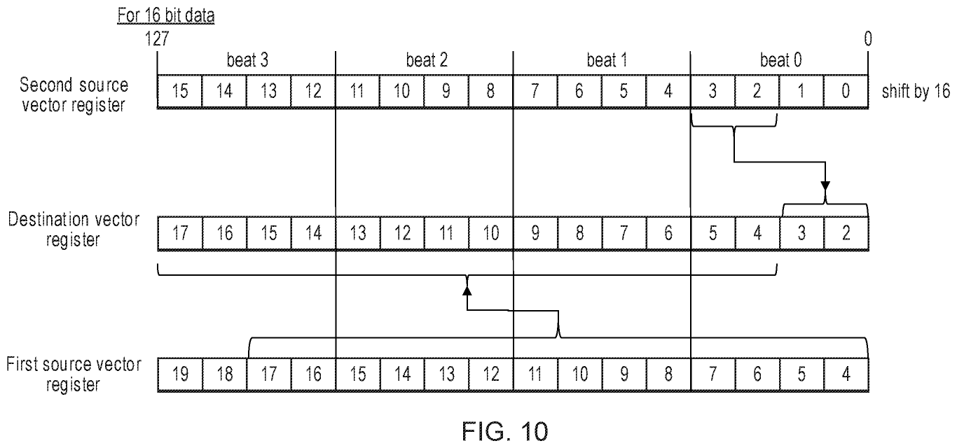

FIG. 10 schematically illustrates an example of a vector extract and merge instruction according to various configurations of the present techniques;

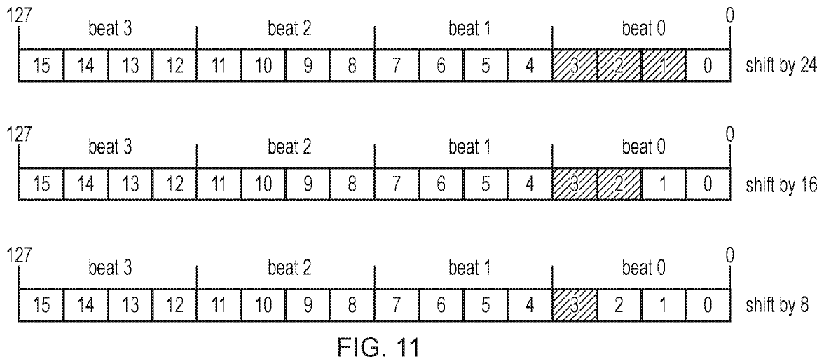

FIG. 11 schematically illustrates an example of a vector extract and merge instruction according to various configurations of the present techniques;

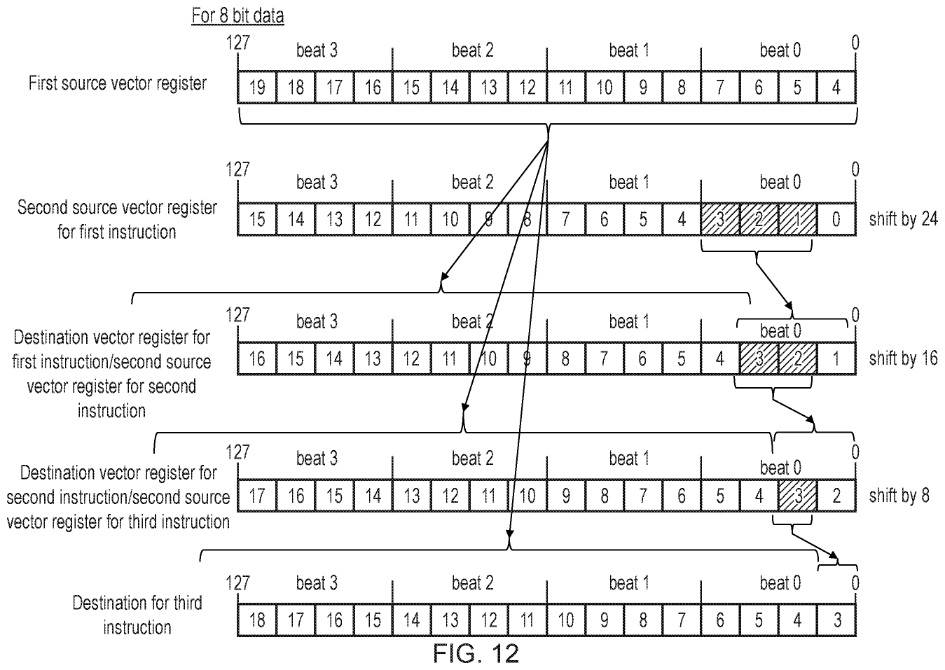

FIG. 12 schematically illustrates an example of a vector extract and merge instruction according to various configurations of the present techniques;

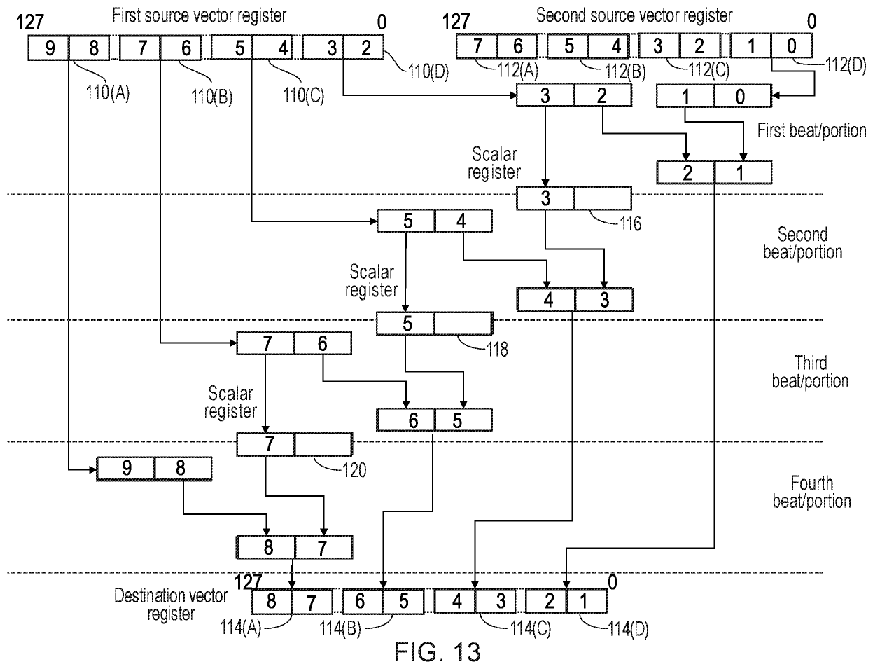

FIG. 13 schematically illustrates an example of a vector extract and merge instruction according to various configurations of the present techniques;

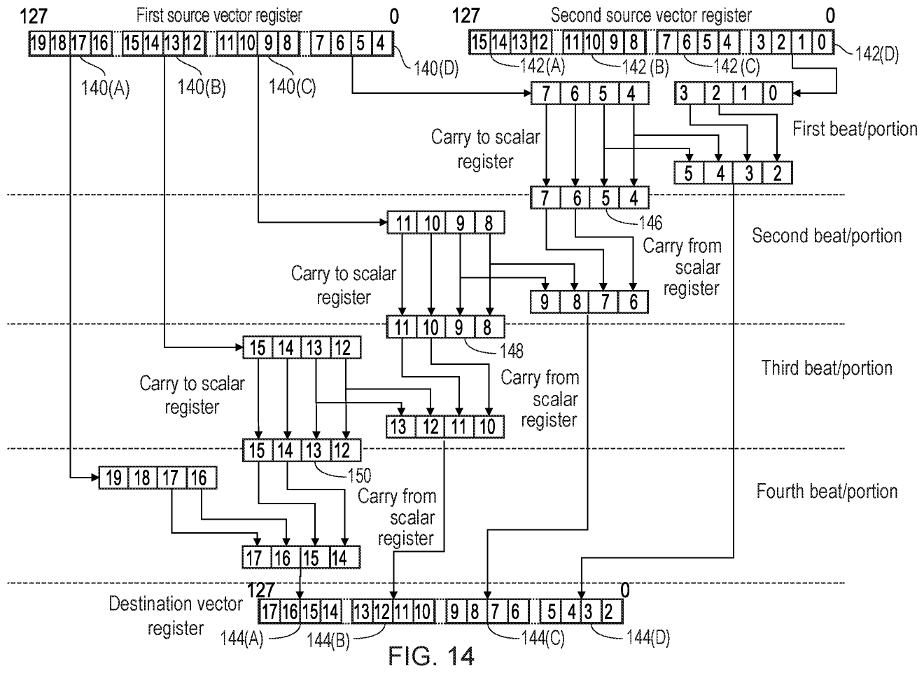

FIG. 14 schematically illustrates an example of a vector extract and merge instruction according to various configurations of the present techniques;

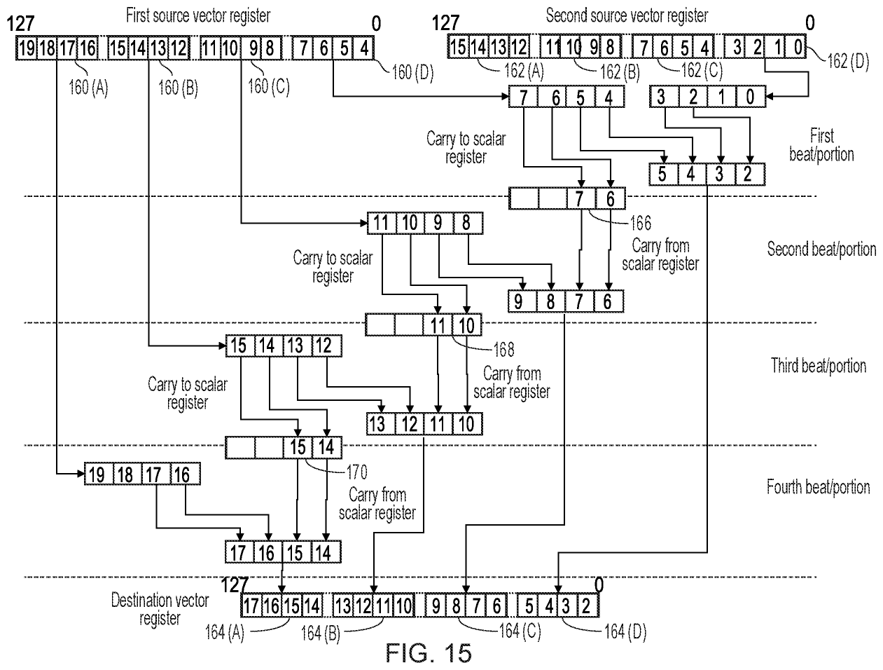

FIG. 15 schematically illustrates an example of a vector extract and merge instruction according to various configurations of the present techniques;

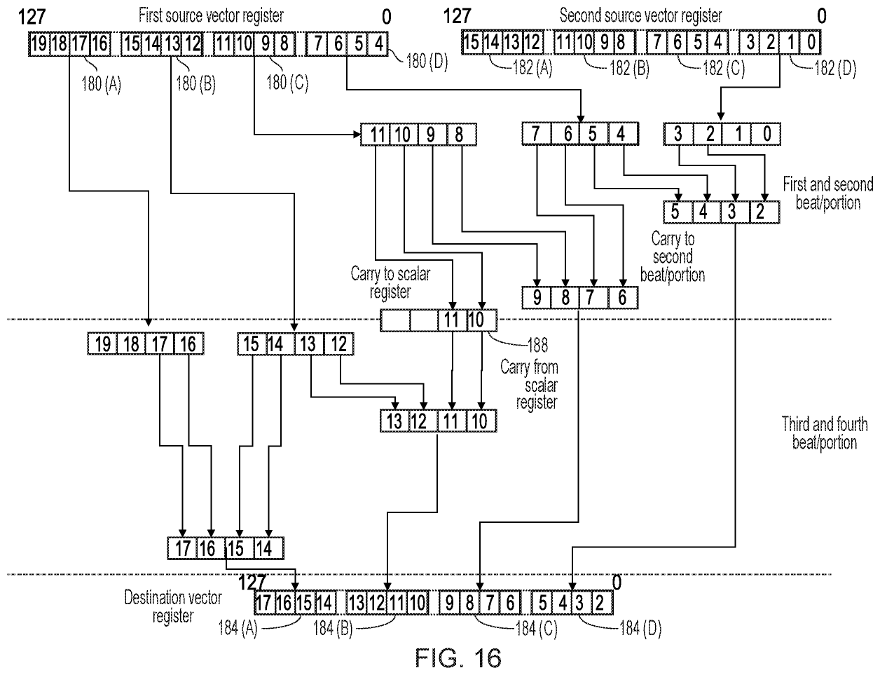

FIG. 16 schematically illustrates an example of a vector extract and merge instruction according to various configurations of the present techniques;

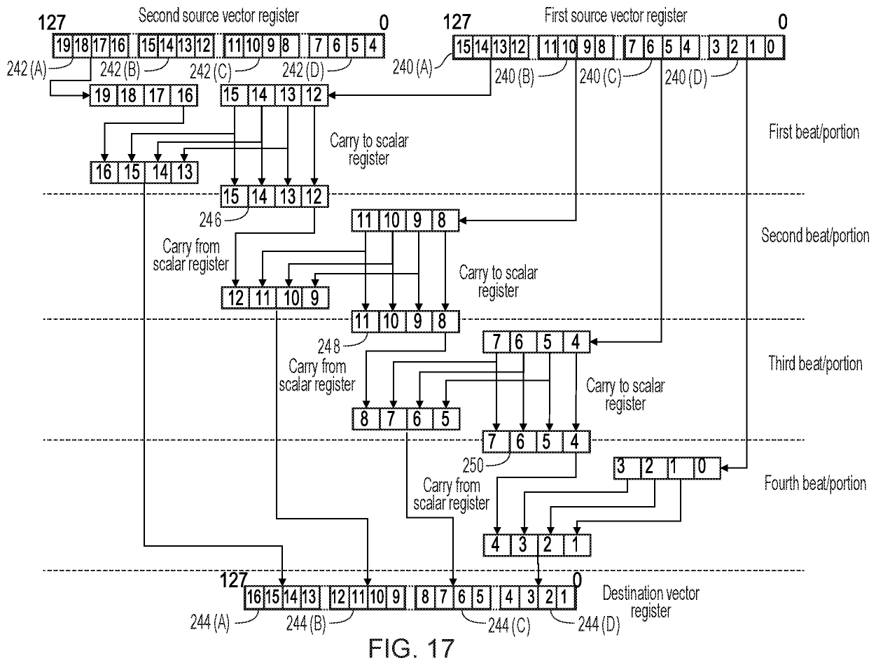

FIG. 17 schematically illustrates an example of a vector extract and merge instruction according to various configurations of the present techniques;

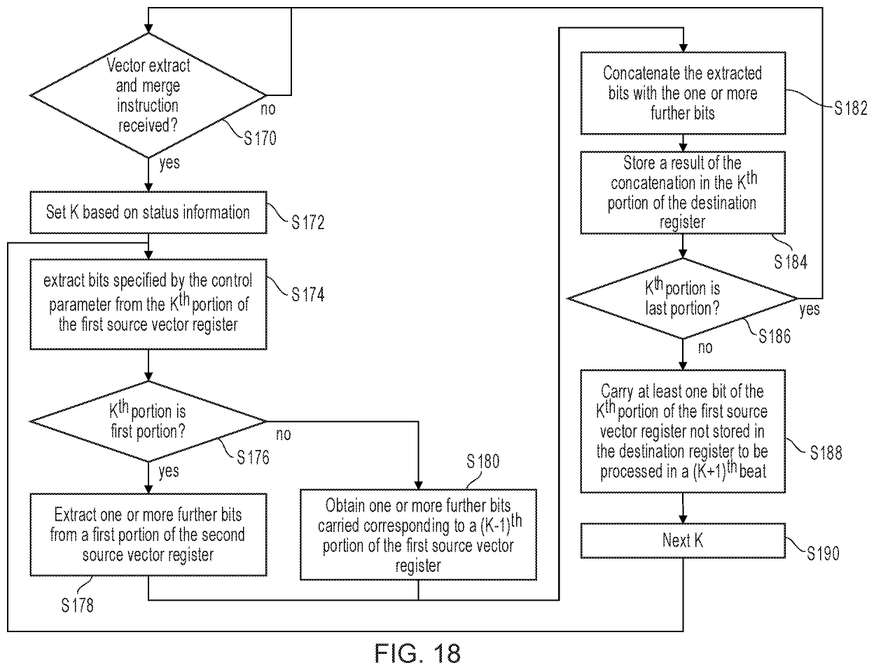

FIG. 18 schematically illustrates a sequence of steps carried out by an apparatus according to various configurations of the present techniques;

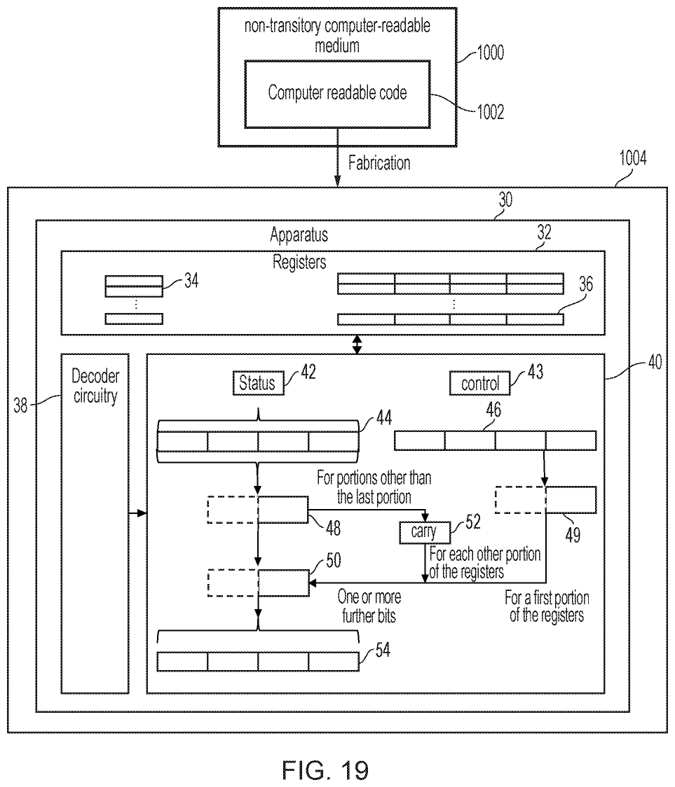

FIG. 19 schematically illustrates an apparatus according to various configurations of the present techniques; and

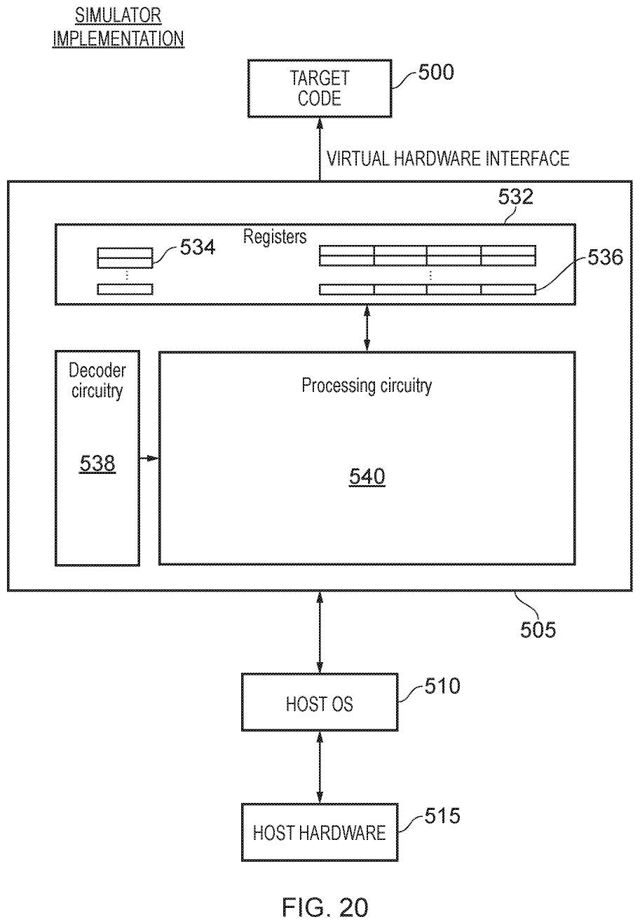

FIG. 20 schematically illustrates a simulator that can be used in accordance with some example configurations.

Software written in accordance with a given instruction set architecture can be executed on a range of different data processing apparatuses having different hardware implementations. As long as a given set of instructions when executed gives the results expected by the architecture, then a particular implementation is free to vary its micro-architectural design in any way which achieves this architecture compliance. For example, for some applications, energy efficiency may be more important than performance and so the micro-architectural design of processing circuitry provided for executing instructions from the instruction set architecture may be designed to consume as little energy as possible even if this is at the expense of performance. Other applications may see performance as a more important criterion than energy efficiency and so may include more complex hardware structures which enable greater throughput of instructions, but which may consume more power. Hence, it can be desirable to design the instruction set architecture so that it supports scaling across a range of different energy or performance points.

In some configurations there is provided an apparatus comprising: a plurality of vector registers and decoder circuitry responsive to a vector extract and merge instruction to generate control signals. The vector extract and merge instruction specifies a control parameter and, as specified registers of the plurality of vector registers, a first source vector register, a second source vector register, and a destination vector register. The apparatus also comprises processing circuitry responsive to the control signals to perform a plurality of beats of processing. Each beat comprising combination processing corresponding to a portion of at least the first source vector register and the destination vector register. The processing circuitry is configured to set beat status information indicative of which beats of the vector extract and merge instruction have completed, and to suppress completed beats of the vector extract and merge instruction indicated by the beat status information as having completed. The combination processing for a K^{th} beat corresponding to a K^{th} portion of each of the specified registers comprises: extracting bits, as specified by the control parameter, from the K^{th} portion of the first source vector register, concatenating the extracted bits with one or more further bits, and storing a result of the concatenation in the K^{th} portion of the destination register. The combination processing for the K^{th} portion comprises, when the K^{th} portion is not a last portion of the specified registers, carrying at least one bit of the K^{th} portion of the first source vector register not stored in the destination register to be processed in a (K+1)^{th} beat of the plurality of beats. For a first portion of the specified registers the one or more further bits are extracted from a first portion of the second source vector register, and for each portion other than the first portion of the specified registers, the one or more further bits are carried from a (K−1)^{th} portion of the first source vector register.

This arrangement enables a micro-architecture supporting vector instructions to scale more efficiently to different performance and energy points. By providing beat status information which tracks the completed beats of two or more vector instructions, this gives freedom for a particular micro-architectural implementation to vary the amount by which execution of different vector instructions is overlapped, so that it is possible to perform respective beats of different vector instructions in parallel with each other while still tracking the progress of each partially executed instruction. Some micro-architectural implementations may choose not to overlap execution of respective vector instructions at all, so that all the beats of one vector instruction are completed before the next instruction starts. Other micro-architectures may stagger the execution of consecutive vector instructions so that a first subset of beats of a second vector instruction is performed in parallel with a second subset of beats from the first vector instruction.

The vector extract and merge instruction is an instruction of an instruction set architecture which is interpreted by decoder circuitry. The instruction set architecture forms a complete set of instructions that can be used by a programmer or compiler to instruct the processing circuitry to perform operations. As discussed, so long as the processing circuitry is compliant with the instruction set architecture, the actual implementation of the micro architecture, i.e., the physical arrangement of the circuits and logical blocks that make up the processing circuitry can vary from implementation to implementation. Some micro-architectural implementations may process all of the portions of the vectors in parallel, while other implementations may process one or more portions of the vector at a time. Some vector instructions, may lend themselves well to such flexibility. For example, a vector instruction that supports element-wise addition of a plurality of elements of two source vectors can be split into plural scalar additions, each corresponding to an element of the vector. However, instructions for which data propagates between different elements or between different portions (which may comprise plural elements of the vector), i.e., instructions in which the different portions are dependent on one another, may not be so readily adapted to such flexibility of the micro-architectural implementation.

The vector extract and merge instruction is one such instruction. In the vector extract and merge instruction, one or more bits from a first source vector register are concatenated with one or more bits from a second source vector register. The inventor has realised that a vector extract and merge instruction providing such micro-architectural flexibility can be implemented by providing processing circuitry arranged to process one or more beats (corresponding to one or more portions of each specified vector register), either in parallel or in a staggered manner, and to carry at least one bit between beats of processing (i.e. from one portion to another). As a result, the processing circuitry does not consider each beat as being truly independent of each other beat. Instead, specific information can be propagated from one processed beat to another processed beat. In particular, the vector extract and merge instruction specifies, as inputs, a control parameter and a plurality of vector registers. The plurality of vector registers includes a first source vector register, a second source vector register and a destination vector register. The control parameter indicates a number of bits that are to be extracted from the first source vector register during each beat of processing and can be specified explicitly in the instruction as a parameter that is passed to the decoder circuitry or can be specified implicitly in the instruction as having a fixed value. For example, the instruction set architecture could define one or more vector extract and merge instructions, each of which implicitly defines a fixed control parameter. The control parameter may be an indicative value and therefore may indirectly specify the number of bits to extract.

The combination processing defined in this way causes a propagation of bits from a first beat (first portion) in which one or more further bits of the second source vector register are concatenated with one or more bits (as specified by the control parameter) that are extracted from the first source vector register. Bits from the first source vector register of the first beat (K=1) are then carried (propagated) to a second beat (K=2) and are concatenated with one or more bits of the first source vector register in the subsequent beat at a time of processing of the subsequent beat. The process is then repeated with one or more bits of the K^{th} beat being carried to the (K+1)^{th} beat. The carry is generated when the K^{th} portion is not the last portion of the specified registers. In some configurations, no carry is generated for the last portion of the specified vector registers. In some alternative configurations, a carry of at least one bit of the last portion of the first source vector register is generated. It will be appreciated that the ordering of the beats may be independent of the ordering of bits within the vector registers. In one configuration the first beat (K=1) may correspond to a least significant set of bits of the vector registers, and the last beat may correspond to a most significant set of bits of the vector register. However in some alternative configurations the first beat (K=1) may correspond to the most significant set of bits of the vector register, and the last beat may correspond to the least significant set of bits of the vector register.

In this way, the apparatus provides processing circuitry that enables an implementation of a vector extract and merge instruction for which the micro-architectural implementation can be varied whilst still allowing compliance with the instruction set architecture, thereby resulting in a flexible implementation that can be adapted based on power constraints and circuit size requirements.

In some configurations the decoder circuitry is responsive to the vector extract and merge instruction specifying a scalar register; the plurality of beats comprises a currently executing subset of one or more beats, wherein the currently executing subset of beats excludes the completed beats; and the processing circuitry is responsive to the control signals, to store at least one item of carry data in the scalar register, the at least one item of carry data comprising one or more bits to be carried between the currently executing subset of one or more beats and a further subset of one or more beats of the plurality of beats. The currently executing subset of beats comprises one or more beats of the plurality of beats and excludes a further subset of at least one beat of the plurality of beats. In such configurations, the scalar register is used to carry the at least one item of carry data between the currently executing subset of beats and the one or more further subset of one or more beats. The scalar register can either be explicitly specified as one of a plurality of scalar registers, for example, as a parameter in the vector extract and merge instruction. Alternatively, the processing circuitry can comprise specific carry register which is implicitly defined in the vector extract and merge instruction.

The carry register can be used to propagate the carry data into the currently executing subset of beats or out of the one currently executing subset of beats. In some configurations, the processing circuitry is responsive to the control signals, for a first beat of the currently executing set of one or more beats and when the beat status information prior to execution of the vector extract and merge instruction indicates that at least one beat is to be suppressed, to retrieve the one or more further bits from the scalar register. The subsets of one or more beats of processing are executed in order with one or more bits of information being propagated from a first subset of beats to a next subset of beats. During execution, the processing circuitry reads the control information to determine which beats comprise the first beat of the currently executing subset of one or more beats. When one or more beats of processing have previously executed, the control information indicates that these one or more beats are to be suppressed. The processing circuitry is therefore able to infer that carry data is available in the scalar register and extracts the one or more further bits from the carry data in the scalar register.

The data that is comprised in the carry data can take various forms. In some configurations the one or more bits to be carried comprises all bits of a portion of the first source vector register; and retrieving the one or more further bits from the scalar register comprises retrieving a last subset of bits from the scalar register. As a result, the extraction of the one or more further bits follows a same pattern independent as to whether the extraction is from the scalar register or from the second source vector register resulting in a simpler implementation, thereby resulting in a simplified implementation. In some configurations the one or more bits to be carried comprises a last set of M bits from a portion of the first source vector register stored to a temporary set of bit positions in the scalar register; and retrieving the one or more further bits from the scalar register comprises retrieving bits from the temporary set of bit positions of the scalar register. As a result fewer bits are required to be carried in the scalar register. In some configurations, the last subset of bits is a most significant subset of bits resulting in a propagation of data from a most significant bits of a (K−1)^{th} portion to a K^{th} portion of the vector registers. In alternative implementations data may be propagated in the opposite direction and, in such configurations, the last subset of bits is a least significant subset of bits.

In some configurations concatenating the extracted bits comprises storing the extracted bits in a first contiguous set of bit positions of the K^{th} portion of the destination register and storing the one or more further bits in a second contiguous set of bit positions of the K^{th} portion of the destination register. In some configurations the union of the first subset of bit positions and the second subset of bit positions comprises all bit positions of the K^{th} portion of the destination register. In some configurations the first contiguous set of bit positions and the second contiguous set of bit positions are non-overlapping bit positions. As a result, all bit positions in the K^{th} portion of the destination register are defined as being either one of the one or more further bits or one of the extracted bits.

The ordering of the first contiguous set of bit positions and the second set of bit positions can be implementation dependent. In some configurations the first contiguous set of bit positions are a most significant set of bit positions of the K^{th} portion of the destination register and the second contiguous set of bit positions are a least significant set of bit positions of the K^{th} portion of the destination register. Alternatively, an order of processing of the specified vectors can be reversed. Hence, in some configurations the first contiguous set of bit positions are a least significant set of bit positions of the K^{th} portion of the destination register and the second contiguous set of bit positions are a most significant set of bit positions of the K^{th} portion of the destination register.

In some configurations the extracted bits are extracted from contiguous bit positions of the K^{th} portion of the first source vector register. The contiguous bit positions are specified by the control parameter and can be defined, for example, based on a first bit position and a second bit position, or based on first bit position and a number of bits to extract.

In some configurations the contiguous bit positions are a set of least significant contiguous bit positions of the K^{th} portion of the first source vector register. In such configurations, the control parameter is only required to specify a number of contiguous bit positions to be extracted. The number of contiguous bit positions to be extracted may be specified as an immediate value or contained within a register that is specified in the vector extract and merge instruction. In alternative configurations the contiguous bit positions are a set of most significant contiguous bit positions of the K^{th} portion of the first source vector register. In some configurations only a subset of the possible number of contiguous bit positions to be extracted may be supported. For example, some configurations may only support the contiguous bit positions being 8, 16, or 24 bits in length. Hence in such configurations the control parameter may indirectly specify the number of contiguous bit positions to be extracted by selecting one of the supported lengths. Such configurations reduce the number of bits required to represent the control parameter.

In some configurations each portion of each of the specified registers is an N-bit portion; the control parameter is indicative of a shift distance M specifying a number of bits; the one or more further bits comprises M bits; and the extracted bits from the K^{th} portion of the first source vector register comprise N minus M bits. As a result, the vector extract and merge instruction combines M bits from the first portion of the second source vector register with N minus M bits of the first portion of the first source vector register to form the first portion of the destination register. Furthermore, the vector extract and merge instruction combines M bits from a (K−1)^{th} portion of the first source vector register with N minus M bits of the K^{th} portion of the first source vector register. In other words, M bits of each portion of the first source vector register are shifted to be stored in a next portion of the destination vector register.

For the first portion of the specified registers, the one or more further elements can be chosen in a variety of ways. In some configurations, each N-bit portion is divided into a plurality of elements; the shift distance corresponds to an integer number of elements; and for the first portion of the specified registers, the one or more further bits comprise a most significant subset of elements of the first portion of the second source vector register. As a result, the shift and merge instruction takes the most significant subset of the second source vector register which are concatenated with bits of the first source vector register to generate the result vector register.

Alternatively, in some configurations each N-bit portion is divided into a plurality of elements; the shift distance corresponds to an integer number of elements; and for the first portion of the specified registers, the one or more further bits comprise a least significant subset of elements of the first portion of the second source vector register excluding a least significant element. There are some use case scenarios in which it may be beneficial to repeatedly apply the vector extract and merge instruction to sequentially generate shifted vectors that are shifted by a number of bits (or a number of elements). For example, when implementing a finite impulse response filter it may be required to sequentially generate vectors that are shifted by a single element from a previous vector in the sequence. The vector extract and merge instruction allows a sequence of shift vectors to be generated by taking an initial vector, for example, the second source vector register, and generating a sequence of vectors shifted by one element. In such cases, rather than retaining first and second source vector registers, a previous destination register may be used as the second source vector register. In such a situation, a location of the necessary bits to be comprised in the one or more further bits has already been shifted by one or more bit positions away from the most significant element. Hence, by selecting as the one or more further bits, in the case of the first portion of the specified register, a least significant subset of elements excluding a least significant element, the vector extract and merge instruction can be adapted for a case in which the second source vector register comprises a result of a preceding vector extract and merge instruction. In some configurations the element width may be controlled by a width parameter of the vector extract and merge instruction. In some configurations the control parameter may be indicative of both which bits to extract, and the element width. In such configurations, the number of bits required to encode the parameters is reduced in situations where only a limited number of combinations of element width and number and position of bits from which to extract are supported.

Rather than specifying separate vector register for each of the first source vector register, the second source vector register and the destination vector register, in some configurations the destination vector register is the second source vector register. Repurposing the second source vector register as the destination register reduces the register requirements and the encoding space required for the vector extract and merge instruction.

As discussed, the vector extract and merge instruction can be flexibly implemented using hardware capable of performing one or more of the plurality of beats of processing in a given cycle. In some configurations the processing circuitry is configured to process at least two of the plurality of beats in parallel. The hardware provision of such processing circuitry may only be sufficient to process the at least two beats and the processing circuitry may be configured to process beats of an adjacent instruction in parallel to processing the at least two of the plurality of beats. Alternatively, the processing circuitry may be sufficient to process all beats of the plurality of beats in parallel.

In some configurations the processing circuitry comprises hardware insufficient for performing all of the plurality of beats of the given vector instruction in parallel. Hence, the processing circuitry may perform a second subset of the beats of a given vector instruction after completing a first subset. The first and second subsets may comprise a single beat or could comprise multiple beats depending on the processor implementation.

In some configurations the processing circuitry is configured to process all of the plurality of beats of the given vector instruction in parallel. Processing circuitry with such hardware can still generate and use the beat status information as specified above, but the beat status information will normally indicate that there were no completed beats. Hence, by defining the beat status information, the architecture can support a range of different implementations.

In some configurations the decoder circuitry is responsive to a memory data transfer instruction, adjacent to the vector extract and merge instruction in program counter order, specifying a memory address and a transfer register of the plurality of vector registers to generate data transfer control signals; the apparatus further comprises data control circuitry responsive to the data transfer control signals to perform a plurality of beats of memory data transfer processing, each beat comprising performing data transfer to a corresponding portion of the transfer register and to set the beat status information indicative of which beats of the data transfer instruction have completed, and to suppress completed beats of the memory data transfer instruction indicated by the beat status information as having completed; and the apparatus is configured to, when the transfer register is one of the specified registers, perform a first subset of the plurality of beats of memory data transfer processing corresponding to a first subset of portions of the transfer register in parallel to the processing circuitry performing, in response to the vector extract and merge instruction, a second subset of the plurality beats of processing corresponding to a second subset of portions of the transfer register. The first subset of beats and the second subset of beats may each comprise the same number of beats or a different number of beats. For example, in some configurations, the apparatus may be provided with hardware that is sufficient for performing a memory data transfer operation for plural portions (corresponding to plural beats of data transfer processing) but only with hardware sufficient for performing a single beat of processing for the vector extract and merge instruction. Alternatively, the apparatus may be provided with sufficient hardware to perform a memory data transfer operation for half of the portions and with hardware sufficient to perform beats of processing for the vector extract and merge instruction for half of the portions of the vector length. In each of these situations, there is no overlap between the data and hardware that is being used for the first subset of the plurality of beats of processing and the second subset of the plurality of beats of processing. Hence, by providing a processing apparatus that is able to parallelise the first subset of beats and the second subset of beats, a greater instruction throughput can be achieved.

In some configurations the control parameter is specified as an immediate value in the vector extract and merge instruction. In some alternative configurations, the control parameter can be specified as a register in which the control parameter is defined.

In some configurations the first portion of the specified registers is a least significant portion of the specified registers and the last portion of the specified registers is a most significant portion of the specified registers. In alternative configurations the first portion of the specified registers is a most significant portion of the specified registers and the last portion of the specified registers is a least significant portion of the specified registers. In this way, the processing apparatus can be provided with circuitry that performs the vector extract and merge instruction by shifting the one or more further bits extracted from the second source vector register into the destination register from a least significant end or a most significant end dependent upon the particular implementation choice.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Specific configurations of the invention will now be described with reference to the accompanying figures.

FIG. 1 schematically illustrates an example of a data processing apparatus 2 supporting processing of vector instructions. It will be appreciated that this is a simplified diagram for ease of explanation, and in practice the apparatus may have many elements not shown in FIG. 1 for conciseness. The apparatus 2 comprises processing circuitry 4 for carrying out data processing in response to instructions decoded by an instruction decoder 6. Program instructions are fetched from a memory system 8 and decoded by the instruction decoder to generate control signals which control the processing circuitry 4 to process the instructions in the way defined by the architecture. For example the decoder 6 may interpret the opcodes of the decoded instructions and any additional control fields of the instructions to generate control signals which cause a processing circuitry 4 to activate appropriate hardware units to perform operations such as arithmetic operations, load/store operations or logical operations. The apparatus has a set of registers 10 for storing data values to be processed by the processing circuitry 4 and control information for configuring the operation of the processing circuitry. In response to arithmetic or logical instructions, the processing circuitry 4 reads operands from the registers 10 and writes results of the instructions back to the registers 10. In response to load/store instructions, data values are transferred between the registers 10 and the memory system 8 via the processing circuitry. The memory system 8 may include one or more levels of cache as well as main memory.

The registers 10 include a scalar register file 12 comprising a number of scalar registers for storing scalar values which comprise a single data element. Some instructions supported by the instructions decoder 6 and processing circuitry 4 are scalar instructions which process scalar operands read from scalar registers 12 to generate a scalar result written back to a scalar register.

The registers 10 also include a vector register file 14 which includes a number of vector registers each for storing a vector value comprising multiple data elements. In response to a vector instruction, the instruction decoder 6 controls the processing circuitry 4 to perform a number of lanes of vector processing on respective elements of a vector operand read from one of the vector registers 14, to generate either a scalar result to be written to the scalar registers 12 or a further vector result to be written to a vector register 14. Some vector instructions may generate a vector result from one or more scalar operands, or may perform an additional scalar operation on a scalar operand in the scalar register file as well as lanes of vector processing on vector operands read from the vector register file 14. Hence, some instructions may be mixed-scalar-vector instructions for which at least one of one or more source registers and a destination register of the instruction is a vector register 14 and another of the one or more source registers and the destination register is a scalar register 12. Vector instructions may also include vector load/store instructions which cause data values to be transferred between the vector registers 14 and locations in the memory system 8. The load/store instructions may include contiguous vector load/store instructions for which the locations in memory correspond to a contiguous range of addresses, or scatter/gather type vector load/store instructions which specify a number of discrete addresses and control the processing circuitry 4 to load data from each of those addresses into respective elements of a vector register or store data from respective elements of a vector register to the discrete addresses.

The processing circuitry 4 may support processing of vectors with a range of different data element sizes. For example a 128-bit vector register 14 could be partitioned into sixteen 8-bit data elements, eight 16-bit data elements, four 32-bit data elements or two 64-bit data elements for example. A control register within the register bank 10 may specify the current data element size being used, or alternatively this may be a parameter of a given vector instruction to be executed.

The registers 10 also include a number of control registers for controlling processing of the processing circuitry 4. For example these may include a program counter register 16 for storing a program counter address which indicates an address of an instruction corresponding to a current execution point being processed, a link register 18 for storing a return address to which processing is to be directed following handling of a function call, a stack pointer register 20 indicating the location within the memory system 8 of a stack data structure, and a beat status register 22 for storing beat status information which will be described in more detail below. It will be appreciated that these are just some of the types of control information which could be stored, and in practice a given instruction set of architecture may store many other control parameters as defined by the architecture. For example, a control register may specify the overall width of a vector register, or the current data element size being used for a given instance of vector processing.

The processing circuitry 4 may include a number of distinct hardware blocks for processing different classes of instructions. For example, load/store instructions which interact with a memory system 8 may be processed by a dedicated load/store unit, while arithmetic or logical instructions could be processed by an arithmetic logic unit (ALU). The ALU itself may be further partitioned into a multiply-accumulate unit (MAC) for performing in operations involving multiplication, and a further unit for processing other kinds of ALU operations. A floating-point unit can also be provided for handling floating-point instructions. Pure scalar instructions which do not involve any vector processing could also be handled by a separate hardware block compared to vector instructions, or reuse the same hardware blocks.

In some applications such as digital signal processing (DSP), there may be a roughly equal number of ALU and load/store instructions and therefore some large blocks such as the MACs can be left idle for a significant amount of the time. This inefficiency can be exacerbated on vector architectures as the execution resources are scaled with the number of vector lanes to gain higher performance. On smaller processors (e.g. single issue, in-order cores) the area overhead of a fully scaled out vector pipeline can be prohibitive. One approach to minimise the area impact whilst making better usage of the available execution resource is to overlap the execution of instructions, as shown in FIG. 2. In this example, three vector instructions include a load instruction VLDR, a multiply instruction VMUL and a shift instruction VSHR, and all these instructions can be executing at the same time, even though there are data dependencies between them. This is because element 1 of the VMUL is only dependent on element 1 of Q1, and not the whole of the Q1 register, so execution of the VMUL can start before execution of the VLDR has finished. By allowing the instructions to overlap, expensive blocks like multipliers can be kept active more of the time.

Hence, it can be desirable to enable micro-architectural implementations to overlap execution of vector instructions. However, if the architecture assumes that there is a fixed amount of instruction overlap, then while this may provide high efficiency if the micro-architectural implementation actually matches the amount of instruction overlap assumed by architecture, it can cause problems if scaled to different micro-architectures which use a different overlap or do not overlap at all.

Instead, an architecture may support a range of different overlaps as shown in the examples of FIG. 3. The execution of a vector instruction is divided into parts referred to as “beats”, with each beat corresponding to processing of a portion of a vector of a predetermined size. A beat is an atomic part of a vector instruction that is either executed fully or not executed at all, and cannot be partially executed. The size of the portion of a vector processed in one beat is defined by the architecture and can be an arbitrary fraction of the vector. In the examples of FIG. 3 a beat is defined as the processing corresponding to one quarter of the vector width, so that there are four beats per vector instruction. Clearly, this is just one example and other architectures may use different numbers of beats, e.g. two or eight. The portion of the vector corresponding to one beat can be the same size, larger or smaller than the data element size of the vector being processed. Hence, even if the element size varies from implementation to implementation or at run time between different instructions, a beat is a certain fixed width of the vector processing. If the portion of the vector being processed in one beat includes multiple data elements, carry signals can be disabled at the boundary between respective elements to ensure that each element is processed independently. If the portion of the vector processed in one beat corresponds to only part of an element and the hardware is insufficient to calculate several beats in parallel, a carry output generated during one beat of processing may be input as a carry input to a following beat of processing so that the results of the two beats together form a data element.

As shown in FIG. 3 different micro-architecture implementations of the processing circuit 4 may execute different numbers of beats in one “tick” of the abstract architectural clock. Here, a “tick” corresponds to a unit of architectural state advancement (e.g. on a simple architecture each tick may correspond to an instance of updating all the architectural state associated with executing an instruction, including updating the program counter to point to the next instruction). It will be appreciated by one skilled in the art that known micro-architecture techniques such as pipelining may mean that a single tick may require multiple clock cycles to perform at the hardware level, and indeed that a single clock cycle at the hardware level may process multiple parts of multiple instructions. However such microarchitecture techniques are not visible to the software as a tick is atomic at the architecture level. For conciseness the micro-architecture is ignored during further description of this disclosure.

As shown in the lower example of FIG. 3, some implementations may schedule all four beats of a vector instruction in the same tick, by providing sufficient hardware resources for processing all the beats in parallel within one tick. This may be suitable for higher performance implementations. In this case, there is no need for any overlap between instructions at the architectural level since an entire instruction can be completed in one tick.

On the other hand, a more area efficient implementation may provide narrower processing units which can only process two beats per tick, and as shown in the middle example of FIG. 3, instruction execution can be overlapped with the first and second beats of a second vector instruction carried out in parallel with the third or fourth beats of a first instruction, where those instructions are executed on different execution units within the processing circuitry (e.g. in FIG. 3 the first instruction is a load instruction executed using the load/store unit and the second instruction is a multiply accumulate instruction executed using the MAC).

A yet more energy/area-efficient implementation may provide hardware units which are narrower and can only process a single beat at a time, and in this case one beat may be processed per tick, with the instruction execution overlapped and staggered by one beat as shown in the top example of FIG. 3 (this is the same as the example shown in FIG. 2 above).

It will be appreciated that the overlaps shown in FIG. 3 are just some examples, and other implementations are also possible. For example, some implementations of the processing circuitry 4 may support dual issue of multiple instructions in parallel in the same tick, so that there is a greater throughput of instructions. In this case, two or more vector instructions starting together in one cycle may have some beats overlapped with two or more vector instructions starting in the next cycle.

As well as varying the amount of overlap from implementation to implementation to scale to different performance points, the amount of overlap between vector instructions can also change at run time between different instances of execution of vector instructions within a program. Hence, the processing circuitry 4 may be provided with beat control circuitry 30 as shown in FIG. 1 for controlling the timing at which a given instruction is executed relative to the previous instruction. This gives the micro-architecture the freedom to select not to overlap instructions in certain corner cases that are more difficult to implement, or dependent on resources available to the instruction. For example, if there are back to back instructions of a given type (e.g. multiply accumulate) which require the same resources and all the available MAC or ALU resources are already being used by another instruction, then there may not be enough free resources to start executing the next instruction and so rather than overlapping, the issuing of the second instruction can wait until the first has completed.

While permitting a range of different overlaps of execution vector instructions can allow more efficient use of hardware resources across a range of performance points, it can cause some complexity for handling of exceptions or debug events or other events which trigger a suspension of the current thread of execution. For example, in the example shown in FIG. 2 if an exception was raised on the fourth tick then the register file would contain a partial update from several instructions. One way of handling this would be to treat the partial updates as speculative states that can be reverted if an exception occurs, but this can increase the amount of hardware required since it may be necessary to buffer store requests for storing data out to the memory system 8 until they are committed and to provide additional registers in hardware for tracking the speculative state. Another approach would be to disable exceptions being taken partway through a vector instruction at all, and delay taking the exception until the oldest uncompleted instruction has completed, but increasing exception handling latency can be undesirable, and in the case where an exception is a precise fault such behaviour may break architecture guarantees associated with the fault.

Instead, as shown in FIG. 4, the beat status register 22 can be used to record a beat status value which tracks which beats of a group of adjacent instructions have completed at the point of an exception, debug event or other event leading to suspension of the current thread. By exposing the overlapping nature of the execution to the architecture, this can help reduce the microarchitecture complexity and increase power and area efficiency.

In the example of FIG. 4, the beat status information tracks the completed beats of a group of three vector instructions A, B, C, where instruction A corresponds to the oldest uncompleted vector instruction, instruction B is the next vector instruction after instruction A and the instruction C is the next vector instruction after instruction B. The notation Ax refers to the x^{th} beat of instruction A, where x is between 1 and 4 for a 4-beat vector implementation, e.g. A2 is the second beat of instruction A. While FIG. 4 shows an example where three instructions are tracked using the beat status information, in other examples which permit a greater number of instructions to be partially completed at a given point, the beat status information could track a greater number of instructions. For example, if dual issue is supported then it may be desirable to indicate beat progress for more than 3 instructions. Each value of the beat status field is allocated to a given combination of completed beats. For example, beat status value 0011 indicates that the first and second beats of instruction A and the first beat of instruction B were completed. The particular mapping of particular encoded values of the beat status information to particular sets of beats of the respective group of instructions is arbitrary and could be varied. The beat status value 0000 in this example indicates that there are no incomplete instructions, and therefore no completed beats of incomplete instructions. This may occur for example when the processor has executed a scalar instruction.

FIG. 5 shows some examples of the beat status information recorded at a point when there is a suspension of the current thread of execution. In the top example of FIG. 5 vector instructions are executed with one beat per tick and on the fourth tick a debug event or exception occurs. Hence, at this point the first three beats of instruction A, the first two beats of instruction B and the first beat of instruction C have already completed but beats A4, B3, C2, D1 are still to be performed. Hence the beat status information would have the value 0111 which according to the example of FIG. 4 indicates that the beats A1, A2, A3, B1, B2 and C1 have completed already.

Similarly, in the bottom of the example of FIG. 5, the instructions being executed were such that instructions B and C could not be overlapped (e.g. because they required use of the same hardware unit), and so this time the instructions C and D had not started yet at the time of the debug event or exception. This time an exception occurring on tick four would trigger the recording of beat status information 0110 indicating that beats A1, A2, A3, B1 and B2 had already completed, but not C1.

Similarly, with the two beats per tick example of FIG. 3, if an exception occurs on tick 2 then only beats A1 and A2 would have completed and the beat status value would be 0010. Note that, while values 0001 and 0010 of the beat status information indicate that only one instruction A was partially completed at the time of the exception, the beat status information still indicates which beats of a group of multiple instructions have completed, since it identifies that none of the beats of the next two instructions B, C have completed.

With the four beat per tick example of FIG. 3 the beat status value would be 0000 regardless of when the exception occurs because there would be no partially completed instructions at the time of the exception since each instruction completes within one tick.

When a debug event or exception occurs, the return address is set to the current value of the program counter 16, which represents the address of the oldest uncompleted instruction. Hence in both the examples of FIG. 5 the return address would be set to the address of instruction A. The return address could be stored in a variety of places, including at a location on a stack relative to the value of a stack pointer register, or in a return address register.

As shown in FIG. 6, this enables the processor in response to a return-from-event request (e.g. on return from the debug mode or the exception handler) to resume processing from a point determined based on the return address and the beat status information in the beat status register 22. The return-from-event request could be made by the debugger in the case of a debug event, or by the exception handler in the case of an exception event. Following the return-from-event request, fetching of instructions to be processed resumes from the address indicated by the return address, which corresponds to instruction A in this case. Instructions B, C and D follow (this example corresponds to the top example of FIG. 5). However, for the first few cycles after the return any beats indicated by the beat status information as already completed are suppressed. The processor may suppress these beats by preventing the corresponding processing operation being performed at all (e.g. suppressing requests to load or store data or disabling of an ALU or MAC). Alternatively, the operation could still be performed in the case of an ALU operation, but the processor may suppress writing of the result of the operation (i.e. suppress updating of a portion of a destination vector register) so that it does not affect the register state. Once the fourth tick is reached then the pipeline has reached the point at which the debug event or exception previously occurred and then processing continues as normal. Hence, for the first few cycles after an exception return, the processor may not perform any useful work and is essentially just refetching multiple instructions that were in flight when the original exception or debug event occurred. However, as exception return latency is often not critical for some applications, this may be a good trade off to reduce the latency at the time of taking the exception, and also this helps to reduce the amount of architectural state that needs to be stored on an exception since it is not necessary to speculatively store results of uncompleted instructions. This approach also enables the handling of exceptions which are precise faults raised by a beat of a vector instruction.

In some cases the beat status information indicating the completed beats of the group of multiple instructions could be set in response to the debug event or exception occurring. However in some implementations it may be easier to update the beat status register each time an instruction completes, regardless of whether an exception has occurred, so that if an exception occurs in the following tick then the beat status register 22 already indicates the already completed beats of the group of instructions.

While FIG. 4 shows one example encoding of the beat status information, another possibility is to provide the beat status information as a bitmap comprising a number of bits each corresponding to one beat of one of the group of instructions A, B, C etc., with each bit set to one if the corresponding beat has completed and zero if the corresponding beat has not completed (or vice versa). However, in practice since a later beat of a given instruction cannot have completed if an earlier beat has not yet completed, then it is not required to provide bits for every beat and it may be more efficient to allocate certain encodings of a smaller bit field to particular combinations of completed beats as in the example of FIG. 4.

FIG. 7 schematically illustrates details of an apparatus 30 arranged according to various configurations of the present techniques. In particular, the apparatus 30 is provided with decoder circuitry 38, processing circuitry 40 and a set of registers 32. The registers 32 comprise one or more scalar registers 34 and one or more vector registers 36. The decoder circuitry is arranged to receive instructions (for example, based on program code generated by a programmer or a compiler) and to interpret the instructions based on an instruction set architecture. In particular, the decoder circuitry is arranged to interpret a vector extract and merge instruction specifying a first source vector register 44, a second source vector register 46, a destination register 54 and a control parameter 43. The decoder circuitry, on receipt of the vector extract and merge instruction generates control signals to cause the processing circuitry 40 to perform vector extract and merge processing. The processing circuitry 40 is responsive to the control signals to perform vector extract and merge processing by performing one or more beats 48 of a plurality of beats of processing. Each beat of processing corresponds to a portion of each of at least the first source vector register 44 and the destination vector register 54. The processing circuitry 40 is arranged to perform one or more beats of processing corresponding to one or more portions 48 of the first source vector register 44, one or more portions 49 of the second source vector register to generate one or more portions 50 to be stored in the destination vector register 50. The processing circuitry 40 is arranged, for a K^{th} beat of processing of the plurality of beats of processing to extract one or more bits from the K^{th} portion of the first source vector register 48 and to concatenate those bits with one or more further bits. Where the K^{th} beat is the first beat of the plurality of beats, the one or more further bits are extracted from a first portion (K^{th} portion for K=1) of the second source vector register 49. Where the K^{th} beat is a beat other than the first beat (K>1), the one or more further bits are carry bits 52 carried from a (K−1)^{th} beat, corresponding to a (K−1)^{th} portion, of the first source vector register 44. Furthermore, the processing circuitry is arranged to output, where the K^{th} beat is not a last beat of the plurality of beats, one or more bits as carry data to be used in a (K+1)^{th} beat of processing.

FIG. 8 schematically illustrates details of a processing apparatus 60 arranged according to some configurations of the present techniques. In particular, the processing apparatus 60 is provided with registers 62, decoder circuitry 68, processing circuitry 70 and data control circuitry 72. The registers 62 comprise a plurality of scalar registers 64 and a plurality of vector registers 66. The decoder circuitry 68 is arranged to generate control signals in response to instructions which form part of the instruction set architecture. The control signals are passed (routed) to the processing circuitry 70 and the data control circuitry 72. The processing circuitry 70 is arranged to perform a plurality of beats of processing in response to a vector extract and merge instruction. The details of the processing circuitry are the same as those of the processing circuitry 40 referred to in FIG. 7. The data control circuitry 72 is responsive to data control signals, that are generated by the decoder circuitry 68 in response to a data transfer instruction, to perform a plurality of beats of memory transfer processing. For a given tick, the apparatus 60 is arranged to perform a plurality of beats comprising a first subset of the plurality of beats of memory transfer processing performed by the data control circuitry 72, and a second subset of the plurality of beats of combination processing in response to the vector extract and merge instruction performed by the processing circuitry 70. The apparatus 60 is arranged to perform the first subset of the plurality of beats and a second subset of the plurality of beats whilst referencing non-overlapping portions of a same vector register 72.

FIG. 9 schematically illustrates details of a vector extract and merge instruction according to some configurations of the present techniques. The vector extract and merge instruction specifies a first source vector register, a second source vector register, a destination vector register and a control parameter M. In the illustrated example, the processing circuitry performs two beats of processing, each corresponding to an N-bit portion of the first source vector register, the second source vector register and the destination register. The first source vector register comprises a first N-bit portion 82. The first N-bit portion 82 comprises a most significant M bits 84 and a least significant N-M bits 86. The processing circuitry is arranged, for the first beat of processing corresponding to the first portion of the first source vector register 82, the first portion of the second source vector register 88, and the first portion of the destination vector register 102 to extract N-M bits 86 of the first portion of the first source vector register 82 and to concatenate the extracted N-M bits with M-bits (one or more further bits) 90 which are extracted from the first portion of the second source vector register 88. Specifically, the N-M bits 86 extracted from the first portion of the first source vector register 82 are stored as a most significant N-M bits 98 of the first portion of the destination vector register 102. The M-bits 90 extracted from the first portion of the second source vector register 88 are stored as a least significant M-bits 100 of the first portion of the destination vector register 102. The processing circuitry is further configured to carry the most significant M-bits 84 of the first portion of the first source vector register 82 as carry bits 96. The carry bits may be carry bits that are carried between beats of processing that are executed in parallel or that are output to a scalar register arranged to carry bits between beats of processing that are not executed in parallel. In a second beat of processing, the M-bits 96 that are carried from the first portion of the first source vector register 82 are stored as a least significant M-bits 94 of the second portion of the destination register. During the second beat of processing, the processing circuitry is arranged to extract a least significant N-M bits 95 of the second N-bit portion of the first source vector register 80 and to store the N-M bits 95 of the second portion of the first source vector register 80 as a most significant N-M bits 92 of the second portion of the destination vector register 104. In this way, the processing circuitry supports a vector extract and merge instruction across a plurality of beats. In this example the control parameter is indicative of the number of M bits 84 to carry between portions (one or more further bits). In other examples the control parameter could be indicative of the number of bits to extract from the first portion of the first source vector register 86 and store in the first portion of the destination vector register.

FIGS. 10-12 schematically illustrate the bits that are extracted from the first portion of the second source vector register according to various configurations of the present techniques. A particular use case of the vector extract and merge instruction is to generate vectors that are not aligned to a 32-bit boundary. In particular, some apparatuses are arranged to load data that is aligned to a 32-bit boundary. Hence, it is relatively straightforward to generate a vector of data values that are shifted by 32-bits. However, generating data that is not aligned with a 32-bit boundary may not be possible using only a load instruction, or may incur a performance penalty such that using aligned loads may be preferable. One approach to generating the data that is not aligned with the 32-bit boundary requires a shift to be performed.

FIG. 10 schematically illustrates a case in which the data stored in the specified registers is 16-bit data. The illustrated first source vector register is split into four beats each comprising four bytes (32 bits). The data that is stored in the first and second source vector registers corresponds to different portions of a same dataset. The data that is stored in the second source vector register has been offset from the data loaded into the first source vector register by 32-bits. For 16-bit data, in accordance with the aforementioned use case, it is desirable to generate a vector shifted by 16 bits. In such a situation, the one or more further bits that are extracted from the second source vector register are bytes 2 and 3 (bits 16-31) of the first portion of the second source vector register. The combination of extracting these bits from the illustrated portion of the second source vector register with the shifted data that is stored in the first source vector register results in the generation of data in the destination vector register that is not aligned to the 32-bit boundary.

FIG. 11 schematically illustrates the portions of the second source vector register that would need to be extracted in order to perform such a shift for 8-bit data. In particular, to generate a set of data that is out of alignment with a 32-bit boundary by 24 bits, bytes 1, 2, and 3 of the second source vector register are extracted as the one or more further bits in the first beat of processing. To generate a set of data that is out of alignment with a 32-bit boundary by 16 bits, bytes 2 and 3 of the second source vector register are extracted as the one or more further bits in the first beat of processing. To generate a set of data that is out of alignment with a 32-bit boundary by 8 bits, byte 3 of the second vector register is extracted as the one or more further bits in the first beat of processing. In this way, it is possible to generate a sequence of vectors with data elements that are not aligned to a 32-bit boundary.

FIG. 12 schematically illustrates the portions of the second source vector register that would need to be extracted in order to perform such a shift for 8-bit data in a case in which the destination data vector is the second source data vector. In the illustrated example, a sequence of three vector extract and merge instructions are applied. Each of the vector extract and merge instructions specifies, as the control parameter, a different number of bits by which to shift the first source vector register. As in the example of FIG. 10, the data that is stored in the second source vector register has been offset from the data loaded into the first source vector register by 32-bits. In the illustrated example, the one or more further bits that are extracted from the second source vector register comprises a least significant set of bytes of the first portion of the second source vector register excluding a least significant byte. In the first vector extract and merge instruction, a shift of 24 bits (3 bytes) is defined as the control parameter. As a result, the bytes that are extracted from the second source vector register are bytes 3, 2 and 1. These are concatenated by the processing circuitry during a plurality of beats of processing to generate, as the content of a destination vector register for the first vector extract and merge instruction, a vector of values that are misaligned from the 32-bit boundary by 24 bits. In the second vector extract and merge instruction, a shift of 16 bits (2 bytes) is defined as the control parameter and the destination vector register of the first vector extract and merge instruction is used as the second source vector register. As a result, the bytes that are extracted from the second source vector register of the second instruction are bytes 3 and 2. These are concatenated by the processing circuitry during a plurality of beats of processing to generate, as the content of a destination vector register for the second vector extract and merge instruction, a vector of values that are misaligned from the 32-bit boundary by 16 bits. In the third vector extract and merge instruction, a shift of 8 bits (1 byte) is defined as the control parameter and the destination vector register of the second vector extract and merge instruction is used as the second source vector register. As a result, the byte that is extracted from the second source vector register is byte 3. This byte is concatenated by the processing circuitry during a plurality of beats of processing to generate, as the content of a destination vector register for the third vector extract and merge instruction, a vector of values that are misaligned from the 32-bit boundary by 8 bits.

FIGS. 13 to 17 schematically illustrate sequence of operations that are carried out by the processing circuitry in response to a vector extract and merge instruction. For illustrative purposes, the elements of the vector registers have been chosen for the use case in which the vector extract and merge instruction is to generate vectors that are not aligned to a 32-bit boundary. It would be readily apparent to the skilled person that this use case example has been chosen purely for illustrative purpose and that the techniques described herein do not require there to be any relationship between the content of the first source vector register and the second source vector register. In particular, it would be apparent that, for the general vector extract and merge instruction described herein, the vector that is stored in the first source vector register can be any first vector either loaded from memory or generated, for example, as a result of one or more other operations. Similarly, the second source vector stored in the second source vector register can be any second vector and that, in some use cases, the programmer may choose to select the first vector and the second vector such that there is some overlap between the elements that are present in the first source vector register and the second source vector register. In other use cases, the programmer may choose to select the first source vector and the second source vector such that there is no overlap between the elements that are present in the first source vector register and the second source vector register.

FIG. 13 schematically illustrates a sequence of operations that are carried out by the processing circuitry in response to a vector extract and merge instruction specifying a first source vector register 110, a second source vector register 112, a destination register 114, a scalar register and control information. Each of the first source vector register 110, the second source vector register 112 and the destination register 114 are arranged as a plurality of portions to be processed in a plurality of beats of processing. In the illustrated example, the processing circuitry is arranged to perform a single beat of processing for a given tick. Each of the portions comprises two elements and the control information specifies that a shift corresponding to a single element is to be performed. For exemplary purposes only, the first source vector register and the second source vector register are 128 bit vector registers and are illustrated as containing a set of numbered data items. In particular, the first source vector register contains data items 9 down to 2 and the second source vector register contains data items 7 down to 0. Hence, the first source vector register and the second source vector register contain 16 bit data items that are loaded from an address in memory that is aligned to a 32 bit boundary. In the first beat of processing, the processing circuitry extracts a least significant element (data item 2) of a first portion of the first source vector register 110(D). The extracted least significant element of the first portion of the first source vector register 110(D) is concatenated with a most significant element (data item 1) of a first portion of the second source vector register 112(D) and the result of the concatenation is stored as a first portion of the destination vector register 114(D). During the first beat of processing, a most significant element (data item 3) of the first portion of the first source vector register 110(D) is extracted as carry data 116 and is stored as a most significant element in a scalar register. During a second beat of processing the processing circuitry extracts a least significant element (data item 4) of the second portion of the first source vector register 110(C). The extracted least significant element of the second portion of the first source vector register 110(C) is concatenated with the carry data 116 stored in a most significant element (data item 3) of the scalar register and a result of the concatenation is stored in a second portion of the destination vector register 114(C). During the second beat of processing the processing circuitry also extracts a most significant element (data item 5) of the second portion of the first source vector register 110(C) as carry data 118 to be stored as a most significant element in the scalar register. During a third beat of processing the processing circuitry extracts a least significant element (data item 6) of the third portion of the first source vector register 110(B). The extracted least significant element of the third portion of the first source vector register 110(B) is concatenated with the carry data 118 stored in a most significant element (data item 5) of the scalar register and a result of the concatenation is stored in a third portion of the destination vector register 114(B). During the third beat of processing the processing circuitry also extracts a most significant element (data item 7) of the third portion of the first source vector register 110(B) as carry data 120 to be stored as a most significant element in the scalar register. During a fourth beat of processing the processing circuitry extracts a least significant element (data item 8) of the fourth portion of the first source vector register 110(A). The extracted least significant element of the fourth portion of the first source vector register 110(C) is concatenated with the carry data 120 stored in a most significant element (data item 7) of the scalar register and a result of the concatenation is stored in a fourth (last) portion of the destination vector register 114(A). In some alternative configurations, during the fourth beat of processing the processing circuitry also extracts a most significant element of the fourth portion of the first source vector register 110(A) as carry data to be stored as a most significant element in the scalar register. This carry data remains stored in the scalar register subsequent to execution of the vector extract and merge instruction. The value in the unused element (the least significant element as shown in FIG. 13) of the scalar register is arbitrary. In some examples this element may be set to a dummy value such as zero. In other examples it may be set to value of the adjacent element from the current portion of the first source vector register.

FIG. 14 schematically illustrates a sequence of operations that are carried out by the processing circuitry in response to a vector extract and merge instruction specifying a first source vector register 140, a second source vector register 142, a destination register 144, a scalar register and control information. As in FIG. 13, each of the first source vector register and the second source vector register contain data items that are extracted from a region of memory that is aligned to a 32-bit boundary. In contrast to FIG. 13, each of the data items stored in an element of the first and second source vector registers is an 8 bit data item. Each of the first source vector register 140, the second source vector register 142 and the destination register 144 are arranged as a plurality of portions to be processed in a plurality of beats of processing. In the illustrated example, the processing circuitry is arranged to perform a single beat of processing for a given tick. Each of the portions comprises four elements and the control information specifies that a shift corresponding to two elements is to be performed. In the first beat of processing, the processing circuitry extracts a least significant two elements (data items 5 and 4) of a first portion of the first source vector register 140(D). The extracted least significant two elements of the first portion of the first source vector register 140(D) are concatenated with a most significant two elements (data items 3 and 2) of a first portion of the second source vector register 142(D) and the result of the concatenation is stored as a first portion of the destination vector register 144(D). During the first beat of processing, the first portion (data items 7 down to 4) of the first source vector register 140(D) is extracted as carry data 146 is stored in a scalar register. During a second beat of processing the processing circuitry extracts a least significant two elements (data items 9 and 8) of the second portion of the first source vector register 140(C). The extracted least significant two elements of the second portion of the first source vector register 140(C) are concatenated with the most significant two elements (data items 7 and 6) of the carry data 146 stored the scalar register and a result of the concatenation is stored in a second portion of the destination vector register 144(C). During the second beat of processing the processing circuitry also extracts the second portion (data items 11 down to 8) of the first source vector register 140(C) as carry data 148 to be stored in the scalar register. During a third beat of processing the processing circuitry extracts a least significant two elements (data items 13 and 12) of the third portion of the first source vector register 140(B). The extracted least significant two elements of the third portion of the first source vector register 140(B) are concatenated with the most significant two elements (items 11 and 10) of the carry data 148 stored in the scalar register and a result of the concatenation is stored in a third portion of the destination vector register 144(B). During the third beat of processing the processing circuitry also extracts the third portion (items 15 down to 12) of the first source vector register 140(B) as carry data 150 to be stored in the scalar register. During a fourth beat of processing the processing circuitry extracts a least significant two elements (data items 17 and 16) of the fourth portion of the first source vector register 140(A). The extracted least significant two elements of the fourth portion of the first source vector register 140(A) are concatenated with the two most significant elements (data items 15 and 14) of the carry data 150 stored in the scalar register and a result of the concatenation is stored in a fourth (last) portion of the destination vector register 144(A). In some alternative configurations, during the fourth beat of processing the processing circuitry also extracts the fourth portion of the first source vector register 140(A) as carry data to be stored in the scalar register. This carry data remains stored in the scalar register subsequent to execution of the vector extract and merge instruction.

FIG. 15 schematically illustrates a sequence of operations that are carried out by the processing circuitry in response to a vector extract and merge instruction according to an alternative implementation. FIG. 15 differs from FIG. 14 in that, for each of the first beat of processing, the second beat of processing, and the third beat of processing, the data that is extracted from the corresponding portion of the first source vector register 160, to be stored as carry data in the scalar register, is a most significant two elements of the corresponding portion and is stored as a least significant two elements of the scalar register. In particular, the operations differ from those described in relation to FIG. 14 as follows: In the first beat of processing the processing circuitry extracts the two most significant elements (data items 7 and 6) of the first portion of the first source vector register 160(D) to store as carry data 166 in a least significant two elements of the scalar register. In the second beat of processing the one or more further bits of data are extracted from the two least significant elements of the scalar register and the processing circuitry extracts the two most significant elements (data items 11 and 10) of the second portion of the first source vector register 160(C) to store as carry data 168 in a least significant two elements of the scalar register. In the third beat of processing the one or more further bits of data are extracted from the two least significant elements of the scalar register and the processing circuitry extracts the two most significant elements (data items 15 and 14) of the third portion of the first source vector register 160(B) to store as carry data 170 in a least significant two elements of the scalar register. In the fourth beat of processing the one or more further bits of data are extracted from the two least significant elements of the scalar register. It will be appreciated that the position of the carry data in the scalar register is arbitrary, and although FIGS. 14 and 15 show two possibilities, other configurations are also possible.

FIG. 16 schematically illustrates a sequence of operations that are carried out by the processing circuitry in response to a vector extract and merge instruction specifying a first source vector register 180, a second source vector register 182, a destination register 184, a scalar register and control information. Each of the first source vector register 180, the second source vector register 182 and the destination register 184 are arranged as a plurality of portions to be processed in a plurality of beats of processing. FIG. 16 differs from FIGS. 15 and 14 in that the processing circuitry is provided with hardware capable of performing two beats of the plurality of beats of processing for a given tick. In other words, two of the beats are performed in parallel. Each of the portions of the first source vector register 180 and the second source vector register 182 comprises four 8-bit elements and the control information specifies that a shift corresponding to two elements is to be performed. In response to a first tick, the processing circuitry performs the first and second beats of processing corresponding to two least significant portions of the first source vector register 180(C), 180(D). The processing circuitry is arranged to extract the most significant two elements (data items 3 and 2) from least significant portion of the second source vector register 182(D) as the one or more further bits. The one or more further bits are concatenated with the two least significant elements (data items 5 and 4) of the least significant portion of the first source vector register 180(D). A result of the concatenation is stored to the least significant portion of the destination vector register 184(D). The two most significant elements (data items 7 and 6) of the least significant portion of the first source vector register 180(D) are carried to be used in the second beat. As the second beat is performed in parallel (in the same tick) as the first beat, the two most significant elements (data items 7 and 6) of the least significant portion of the first source vector register 180(D) are carried without requiring the scalar register. Hence, in the same tick, as part of the second beat of processing, the two most significant elements (data items 7 and 6) of the least significant portion of the first source vector register 180(D) are carried as the one or more further bits to be concatenated with the two least significant elements (data items 9 and 8) of the second portion of the first source vector register 180(C). A result of the concatenation is stored to the second portion of the destination vector register 184(C). The processing circuitry is also arranged to store the two most significant elements (data items 11 and 10) from the second portion of the first source vector register 180(C) to the two least significant elements of the scalar register 188 to be carried for processing during the next tick. The processing circuitry is also arranged to set status information indicating that processing has been completed for the first and second beat of processing that is to be carried out in response to the vector extract and merge instruction.

During a second beat of processing, the processing circuitry can determine, from the status information, that processing is completed for the first and second beat of processing. Hence, the processing circuitry begins processing from the third beat corresponding to a third portion of the first source vector register 180(B). The processing circuitry extracts the two least significant elements (data items 13 and 12) from the third portion of the first source vector register 180(B) and concatenates these elements with one or more further bits. Because the processing circuitry can determine that the beats that are being processed do not comprise the first beat (least significant portion), the one or more further bits are extracted from the scalar register 188. In particular, the one or more further bits comprise the two least significant elements (data items 11 and 10) of the scalar register 188 which are extracted and concatenate with the two least significant elements (data items 13 and 12) of the third portion of the first source vector register 180(B) and a result of the concatenation is stored in the third portion of the destination register 184(B). The processing circuitry is also arranged to extract the two most significant elements (data items 15 and 14) of the third portion of the first source vector register 180(B) to be carried to the fourth beat. Because the processing circuitry is able to perform two beats of processing in a given tick, beats 3 and 4 are performed in parallel and the carried data does not require storage in the scalar register 188. Rather, the two most significant elements (data items 15 and 14) of the third portion of the first source vector register 180(B) are carried as the one or more further bits to be used in the fourth beat. During the fourth beat the two least significant elements (data items 17 and 16) of the fourth (most significant) portion of the first source vector register 180(A) are extracted and concatenated with the carried one or more further bits from the third portion of the first source vector register. The result of the concatenation is stored in a fourth portion (most significant portion) of the destination vector register 184(A).

In some alternative configurations, during the fourth beat of processing the processing circuitry also extracts the fourth portion of the first source vector register 180(A) as carry data to be stored in the scalar register 188. This carry data remains stored in the scalar register 188 subsequent to execution of the vector extract and merge instruction to, potentially, be used as part of a further instruction.

FIG. 17 schematically illustrates an alternative configuration in which a sequence of operations is carried out by the processing circuitry in response to a vector extract and merge instruction specifying a first source vector register 240, a second source vector register 242, a destination register 244, a scalar register and control information. FIG. 17 differs from FIGS. 14-16 in that the extract and merge instruction has been reversed. In particular, the vector extract and merge instruction is carried out from a most significant portion of the specified registers rather than from a least significant portion of the source vector registers. In the illustrated example, the processing circuitry is arranged to perform a single beat of processing for a given tick. Each of the portions comprises four elements and the control information specifies that a shift corresponding to one element is to be performed. In the first beat of processing (in this case, corresponding to the most significant portion of the specified registers), the processing circuitry extracts a most significant three elements (data items 15 down to 13) of a first portion (most significant portion) of the first source vector register 240(A). The extracted most significant three elements of the first portion of the first source vector register 240(A) are concatenated with a least significant element (data item 16) of a first portion (most significant portion) of the second source vector register 242(A) and the result of the concatenation is stored as a first portion of the destination vector register 244(A). During the first beat of processing, the first portion (data items 15 down to 12) of the first source vector register 240(A) is extracted as carry data 246 and is stored in a scalar register. During a second beat of processing the processing circuitry extracts a most significant three elements (data items 11 down to 9) of the second portion of the first source vector register 240(B). The extracted most significant three elements of the second portion of the first source vector register 240(B) are concatenated with the least significant element (data item 12) of the carry data 246 stored the scalar register and a result of the concatenation is stored in a second portion of the destination vector register 244(B). During the second beat of processing the processing circuitry also carries the second portion (data items 11 down to 8) of the first source vector register 240(B) as carry data 248 to be stored in the scalar register. During a third beat of processing the processing circuitry extracts a most significant three elements (data items 7 down to 5) of the third portion of the first source vector register 240(C). The extracted most significant three elements of the third portion of the first source vector register 240(C) are concatenated with the least significant element (data item 8) of the carry data 248 stored in the scalar register and a result of the concatenation is stored in a third portion of the destination vector register 244(C). During the third beat of processing the processing circuitry also extracts the third portion (data items 7 down to 4) of the first source vector register 240(C) as carry data 250 to be stored in the scalar register. During a fourth beat of processing the processing circuitry extracts a most significant three elements (data items 3 down to 1) of the fourth portion (least significant portion) of the first source vector register 210(D). The extracted most significant three elements of the fourth portion of the first source vector register 210(D) are concatenated with least significant element (data item 4) of the carry data 250 stored in the scalar register and a result of the concatenation is stored in a fourth (least significant) portion of the destination vector register 244(D). In some alternative configurations, during the fourth beat of processing the processing circuitry also extracts the fourth portion of the first source vector register 240(D) as carry data to be stored in the scalar register. This carry data remains stored in the scalar register subsequent to execution of the vector extract and merge instruction. As shown in the previous figures, the position of the data elements to be carried within the scalar register, and the value of the unused elements in the scalar register, are arbitrary. Various combinations of other configurations are possible, for example, storing the elements to carry in the most significant elements of the scalar register, and setting unused elements to zero.

FIG. 18 schematically illustrates a sequence of steps carried out by the processing circuitry in response to a vector extract and merge instruction. Flow begins at step S170 where it is determined if a vector extract and merge instruction specifying a first source vector register, a second source vector register, a destination vector register and a control parameter has been received by the decoder circuitry. If no then flow remains at step S170. If, at step S170, it is determined that the decoder circuitry has received a vector extract and merge instruction then the decoder circuitry generates control signals based on the vector extract and merge instruction. Flow then proceeds to step S172 where, based on the control signals, a value K is set based on the status information. If the status information indicates that no beats of processing have been carried out, then K is set to indicate the first beat of processing. If on the other hand, the status information indicates that a first one or more beats of the plurality of beats have been completed then K is set to indicate a first non-completed beat of the plurality of beats. Flow then proceeds to step S174 where the processing circuitry extracts the bits specified by the control parameter from the K^{th} portion of the first source vector register. Flow then proceeds to step S176 where it is determined whether K indicates that the portion is the first portion. If so then flow proceeds to step S178 where the processing circuitry extracts one or more further bits (as indicated by the control parameter) from a first portion of the second source vector register. Flow then proceeds to step S182. If on the other hand, at step S176, it was determined that K indicated that the K^{th} portion is not the first portion, then flow proceeds to step S180 where one or more further bits are obtained as one or more further bits carried from a (K−1)^{th} portion of the first source vector register. The carry may be an internal carry within the processing circuitry, for example, if the processing circuitry is provided with sufficient hardware to perform more than 1 beat per tick. Alternatively, the carry data may be extracted from a scalar register where the one or more further bits have been stored as part of a preceding beat of the vector extract and merge instruction. Flow then proceeds to step S182. At step S182, the one or more extracted bits are concatenated with the one or more further bits. Flow then proceeds to step S184, where the result of the concatenation is stored in a K^{th} portion of the destination register. Flow then proceeds to step S186, where it is determined if the K^{th} portion is the last portion of the first source vector register. If yes, then flow returns to step S170. If, at step S186, it was determined that the K^{th} portion is not the last portion then flow proceeds to step S188, where at least one bit of the K^{th} portion of the first source vector register that has not been stored in the destination register is carried to be processed in a (K+1)^{th} beat. The carry may be an internal carry within the processing circuitry, for example, if the processing circuitry is provided with sufficient hardware to perform multiple (plural) beats of processing per tick. Alternatively, the carry may be performed by storing the at least one bit of the K^{th} portion of the first source vector register to a scalar register specified in the vector extract and merge instruction. Flow then proceeds to step S190 where K is incremented and flow returns to step S174.

Whilst the sequence of steps of FIG. 18 has been described by sequentially incrementing K, where hardware is provided that is sufficient to perform plural beats of processing per tick, the steps corresponding to each beat (each value of K) that are being performed within that same tick, are performed in parallel. For example, if beats K and K+1 were being performed in parallel then step S174 would comprise extracting the bits specified by the control parameter from the K^{th} portion of the first source vector register in parallel to extracting the bits specified by the control parameter for the (K+1)^{th} portion of the first source vector register. The one or more further bits for each of the K and (K+1)^{th} beats would then be extracted in parallel. Potentially, if K indicates that the K^{th} portion is the first portion, the one or more further bits for the K^{th} portion would be extracted from the second source vector register in parallel to the one or more further bits for the (K+1)^{th} portion being extracted from the K^{th} portion of the first source vector register. The step of concatenation S182 would be performed in parallel for the K^{th} and (K+1)^{th} portions, and the step of storage S184 for the K^{th} and (K+1)^{th} portions would be performed in parallel. The determination at step S186 as to whether K corresponds to a last portion would be made based on the highest portion (most significant portion) of K that is being processed and, if flow were to continue, based on this determination, to step S188, the carry would be extracted from the (K+1)^{th} portion for processing in a subsequent tick. It would be appreciated by the skilled person that, dependent on the details of the hardware provision, any number of beats of processing could be performed in parallel.

FIG. 19 schematically illustrates a non-transitory computer-readable medium comprising computer readable code for fabrication of a data processing apparatus according to various configurations of the present techniques. Fabrication is carried out based on computer readable code 1002 that is stored on a non-transitory computer-readable medium 1000. The computer-readable code can be used at one or more stages of a semiconductor design and fabrication process, including an electronic design automation (EDA) stage, to fabricate an integrated circuit comprising the apparatus embodying the concepts. The fabrication process involves the application of the computer readable code 1002 either directly into one or more programmable hardware units such as a field programmable gate array (FPGA) to configure the FPGA to embody the configurations described hereinabove or to facilitate the fabrication of an apparatus implemented as one or more integrated circuits or otherwise that embody the configurations described hereinabove. By way of example, the fabricated design 1004 comprises apparatus 30 with registers 32, decoder circuitry 38 and processing circuitry 40 as described in relation to FIG. 7. However, the fabricated design may correspond to any of the circuits set out in FIGS. 1, 7, and 8 capable of implementing the vector extract and merge instruction as described in relation to FIGS. 9-18.

FIG. 20 illustrates a simulator implementation that may be used. Whilst the earlier described examples implement the present invention in terms of apparatus and methods for operating specific processing hardware supporting the techniques concerned, it is also possible to provide an instruction execution environment in accordance with the examples described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically a simulator implementation may run on a host processor 515, optionally running a host operating system 510, supporting the simulator program 505. In some arrangements there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990, USENIX Conference, Pages 53 to 63.

To the extent that examples have previously been described with reference to particular hardware constructs or features, in a simulated implementation equivalent functionality may be provided by suitable software constructs or features. For example, particular circuitry may be provided in a simulated implementation as computer program logic. Similarly, memory hardware, such as register or cache, may be provided in a simulated implementation as a software data structure. In arrangements where one or more of the hardware elements referenced in the previously described examples are present on the host hardware, some simulated implementations may make use of the host hardware, where suitable.

The simulator program 505 may be stored on a computer readable storage medium (which may be a non-transitory medium), and provides a virtual hardware interface (instruction execution environment) to the target code 500 (which may include applications, operating systems and a hypervisor) which is the same as the hardware interface of the hardware architecture being modelled by the simulator program 505. Thus, the program instructions of the target code 500 may be executed from within the instruction execution environment using the simulator program 505, so that a host computer 515 which does not actually have the hardware features of the apparatus 30 discussed above can emulate those features. The simulator program may include register logic 532 to emulate the behaviour of the registers 32, decoder circuitry logic 538 to emulate the behaviour of the decoder circuitry 38 and processing logic 540 to emulate the behaviour of the processing circuitry 40. In addition, the simulator program may include logic to implement any of the circuits set out in FIGS. 1, 7, and 8 capable of implementing the vector extract and merge instruction as described in relation to FIGS. 9-18. Hence, the techniques described herein can in the example of FIG. 20 be performed in software by the simulator program 505.

In brief overall summary there is provide an apparatus, method and medium. The apparatus comprises decoder circuitry to generate control signals in response to a vector extract and merge instruction specifying a control parameter, a first vector register, a second vector register, and a destination vector register. The apparatus comprises processing circuitry responsive to the control signals, to perform plural beats of processing, each beat comprising processing corresponding to a portion of at least the first vector register and the destination vector register. The processing, for a K^{th} beat comprises: extracting bits, specified by the control parameter, from a K^{th} portion of the first vector register, concatenating the bits with further bits, and storing the result in the K^{th} portion of the destination register. The further bits are, for a first portion, extracted from a first portion of the second vector register and, otherwise, from a (K−1)^{th} portion of the first vector register.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative configurations have been described in detail herein with reference to the accompanying drawings, it is to be understood that the invention is not limited to those precise configurations, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
a plurality of vector registers;
decoder circuitry responsive to a vector extract and merge instruction to generate control signals, the vector extract and merge instruction specifying a control parameter and, as specified registers of the plurality of vector registers, a first source vector register, a second source vector register, and a destination vector register; and
processing circuitry responsive to the control signals to perform a plurality of beats of processing, each beat comprising combination processing corresponding to a portion of at least the first source vector register and the destination vector register, wherein the processing circuitry is configured to set beat status information indicative of which beats of the vector extract and merge instruction have completed, and to suppress completed beats of the vector extract and merge instruction indicated by the beat status information as having completed,
wherein the combination processing for a K^{th} beat corresponding to a K^{th} portion of each of the specified registers comprises:
extracting bits, as specified by the control parameter, from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register.

2. The apparatus of claim 1, wherein:
the decoder circuitry is responsive to the vector extract and merge instruction specifying a scalar register;
the plurality of beats comprises a currently executing subset of one or more beats, wherein the currently executing subset of beats excludes the completed beats; and
the processing circuitry is responsive to the control signals, to store at least one item of carry data in the scalar register, the at least one item of carry data comprising one or more bits to be carried between the currently executing subset of one or more beats and a further subset of one or more beats of the plurality of beats.

3. The apparatus of claim 2, wherein the processing circuitry is responsive to the control signals, for a first beat of the currently executing set of one or more beats and when the beat status information prior to execution of the vector extract and merge instruction indicates that at least one beat is to be suppressed, to retrieve the one or more further bits from the scalar register.

4. The apparatus of claim 3, wherein one of:
the one or more bits to be carried comprises all bits of a portion of the first source vector register, and
retrieving the one or more further bits from the scalar register comprises retrieving a last subset of bits from the scalar register, and
the one or more bits to be carried comprises a last set of M bits from a portion of the first source vector register stored to a temporary set of bit positions in the scalar register; and retrieving the one or more further bits from the scalar register comprises retrieving bits from the temporary set of bit positions of the scalar register.

5. (canceled)

6. The apparatus of claim 1, wherein concatenating the extracted bits comprises storing the extracted bits in a first contiguous set of bit positions of the K^{th} portion of the destination register and storing the one or more further bits in a second contiguous set of bit positions of the K^{th} portion of the destination register.

7. The apparatus of claim 6, wherein the first contiguous set of bit positions and the second contiguous set of bit positions are non-overlapping bit positions.

8. The apparatus of claim 6, wherein the first contiguous set of bit positions are one of:
a most significant set of bit positions of the K^{th} portion of the destination register and the second contiguous set of bit positions are a least significant set of bit positions of the K^{th} portion of the destination register; and
a least significant set of bit positions of the K^{th} portion of the destination register and the second contiguous set of bit positions are a most significant set of bit positions of the K^{th} portion of the destination register; and
a least significant set of bit positions of the K^{th} portion of the destination register and the second contiguous set of bit positions are a most significant set of bit positions of the K^{th} portion of the destination register.

9. (canceled)

10. The apparatus of claim 1, wherein the extracted bits are extracted from contiguous bit positions of the K^{th} portion of the first source vector register.

11. The apparatus of claim 10, wherein the contiguous bit positions are a set of least significant contiguous bit positions of the K^{th} portion of the first source vector register.

12. The apparatus of claim 1, wherein:
each portion of each of the specified registers is an N-bit portion;
the control parameter is indicative of a shift distance M specifying a number of bits;
the one or more further bits comprises M bits; and
the extracted bits from the K^{th} portion of the first source vector register comprise N minus M bits.

13. The apparatus of claim 12, wherein:
each N-bit portion is divided into a plurality of elements;
the shift distance corresponds to an integer number of elements; and
for the first portion of the specified registers, the one or more further bits comprise a least significant subset of elements of the first portion of the second source vector register excluding a least significant element.

14. The apparatus of claim 12, wherein:
each N-bit portion is divided into a plurality of elements;
the shift distance corresponds to an integer number of elements; and
for the first portion of the specified registers, the one or more further bits comprise a most significant subset of elements of the first portion of the second source vector register.

15. The apparatus of claim 1, wherein the destination vector register is the second source vector register.

16. The apparatus of claim 1, wherein the processing circuitry is configured to process at least two of the plurality of beats in parallel.

17. The apparatus of claim 1, wherein one of:
the processing circuitry comprises hardware insufficient for performing all of the plurality of beats of the given vector instruction in parallel; and
the processing circuitry is configured to process all of the plurality of beats of the given vector instruction in parallel.

18. (canceled)

19. The apparatus of claim 1, wherein:
the decoder circuitry is responsive to a memory data transfer instruction, adjacent to the vector extract and merge instruction in program counter order, specifying a memory address and a transfer register of the plurality of vector registers to generate data transfer control signals;
the apparatus further comprises data control circuitry responsive to the data transfer control signals to perform a plurality of beats of memory data transfer processing, each beat comprising performing data transfer to a corresponding portion of the transfer register and to set the beat status information indicative of which beats of the data transfer instruction have completed, and to suppress completed beats of the memory data transfer instruction indicated by the beat status information as having completed; and
the apparatus is configured to, when the transfer register is one of the specified registers, perform a first subset of the plurality of beats of memory data transfer processing corresponding to a first subset of portions of the transfer register in parallel to the processing circuitry performing, in response to the vector extract and merge instruction, a second subset of the plurality beats of processing corresponding to a second subset of portions of the transfer register.

20. The apparatus of claim 1, wherein the control parameter is specified as an immediate value in the vector extract and merge instruction.

21. (canceled)

22. A method of operating an apparatus comprising a plurality of vector registers, decoder circuitry and processing circuitry, the method comprising:
generating, using the decoder circuitry and in response to a vector extract and merge instruction, control signals, the vector extract and merge instruction specifying a control parameter and, as specified registers of the plurality of vector registers, a first source vector register, a second source vector register, and a destination vector register; and
performing, using the processing circuitry and in response to the control signals, a plurality of beats of processing, each beat comprising combination processing corresponding to a portion of at least the first source vector register and the destination vector register, setting beat status information indicative of which beats of the vector extract and merge instruction have completed, and suppressing completed beats of the vector extract and merge instruction indicated by the beat status information as having completed,
wherein the combination processing for a K^{th} beat corresponding to a K^{th} portion of each of the specified registers comprises:
extracting bits specified by the control parameter from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register

23. A computer-readable medium to store computer-readable code for fabrication of an apparatus of claim 1.

24. A computer program for controlling a host data processing apparatus to provide an instruction execution environment, comprising:
register logic comprising a plurality of vector registers;
decoder logic responsive to a vector extract and merge instruction to generate control signals, the vector extract and merge instruction specifying a control parameter and, as specified registers of the plurality of vector registers, a first source vector register, a second source vector register, and a destination vector register; and
processing logic responsive to the control signals to perform a plurality of beats of processing, each beat comprising combination processing corresponding to a portion of at least the first source vector register and the destination vector register, wherein the processing logic is configured to set beat status information indicative of which beats of the vector extract and merge instruction have completed, and to suppress completed beats of the vector extract and merge instruction indicated by the beat status information as having completed,
wherein the combination processing for a K^{th} beat corresponding to a K^{th} portion of each of the specified registers comprises:
extracting bits specified by the control parameter from the K^{th} portion of the first source vector register, concatenating the extracted bits with one or more further bits, and storing a result of the concatenation in the K^{th} portion of the destination register;
when the K^{th} portion is not a last portion of the specified registers, carrying at least one bit of the K^{th} portion of the first source vector register not stored in the destination register to be processed in a (K+1)^{th} beat of the plurality of beats;
for a first portion of the specified registers the one or more further bits are extracted from a first portion of the second source vector register; and
for each portion other than the first portion of the specified registers, the one or more further bits are carried from a (K−1)^{th} portion of the first source vector register.
